(19) United States
(12) Patent Application Publication
(10) Pub. No.: US 2026/0335762 A1
(43) Pub. Date: Oct. 29, 2026

(54) FOOT-OPERATED GAME CONTROLLER

(71) Applicant: DONGGUAN TAIQU TECHNOLOGY CO., LTD., Dongguan (CN)

(72) Inventor: He Li, Guangzhou (CN)

(21) Appl. No.: 19/704,358

(22) Filed: Jun. 10, 2026

Related U.S. Application Data
(63) Continuation of application No. PCT/CN2025/134980, filed on Nov. 14, 2025.

(30) Foreign Application Priority Data
Dec. 9, 2024 (CN) 202411800721.0
Dec. 30, 2024 (CN) 202423282101.0
Mar. 10, 2025 (CN) 202510282677.7

(51) Int. Cl. A63F 13/245; A63F 13/803; A63F 13/822; A63F 13/837

(52) U.S. Cl. CPC A63F 13/245; A63F 13/803; A63F 13/822; A63F 13/837

(57) ABSTRACT

A foot-operated game controller comprises a pedal and a six-axis shaft assembly including a left-right shaft and a front-rear shaft. A pair of upper support frames is provided on the bottom of the pedal. Two ends of the left-right shaft are provided with first connecting rods connected to compression spring devices, and a second potentiometer is arranged beside the upper support frames. A lower plate is arranged below the shaft assembly and provided with lower support frames. Two ends of the front-rear shaft are connected to torsion spring devices, and a first potentiometer is mounted on the lower support frames. The first and second potentiometers are electrically connected to a main control board. By stepping on the pedal, a player can control in-game objects, making the controller suitable for users with hand disabilities and for gaming scenarios requiring frequent multi-key switching.

### CROSS-REFERENCE TO RELATED APPLICATIONS

This application is a U.S. National Stage of International Patent Application No. PCT/CN2025/134980 filed on Nov. 14, 2025. which claims priority to Chinese Patent Application No. 202510282677.7, filed on Mar. 10, 2025; which claims priority to Chinese Patent Application No. 202423282101.0, filed on Dec. 30, 2024; which claims priority to Chinese Patent Application No. 202411800721.0, filed on Dec. 9, 2024. The aforementioned applications are hereby incorporated by reference in their entirety.

### TECHNICAL FIELD

The present application relates to the technical field of game control, and in particular, for example, to a foot-operated game controller.

### BACKGROUND

A wide variety of game controllers have emerged on the market, including commonly used mouse-and-keyboard setups, arcade-style joysticks, game console controllers, controllers dedicated to mobile devices, and customized controllers optimized for specific games, thereby satisfying the diverse needs of different players, such as professional steering wheels designed for racing games and flight sticks developed for flight simulation games.

However, when a game controller is held and operated for a long time, the hand muscles remain in a continuously tense state. In particular, in intense competitive games, players need to press buttons frequently and move joysticks rapidly, and the frequent contraction and relaxation of the hand muscles easily causes fatigue. For example, after playing action games continuously for several hours, a player may experience soreness and stiffness in the hands, thereby affecting the subsequent gaming experience. At the same time, for players whose hands are inconvenient to use for operating a manual game controller (or who have hand disabilities), such controllers are not convenient to use.

Therefore, the prior art is still insufficient to meet user needs.

### SUMMARY

The technical problem to be solved by the present application is to provide, in view of the limitations of the prior art, a foot-operated game controller capable of accurately controlling an object in a game by means of a pedal, thereby providing players with a richer and more immersive gaming experience, freeing some of the player's fingers to control other buttons, and being especially suitable for players whose hands are inconvenient to use or who have hand disabilities.

The technical solution adopted by the present application to solve the above technical problem is as follows.

A foot-operated game controller, comprising:

A six-axis shaft assembly comprising a front-rear shaft and a left-right shaft;

A pedal positioned above the six-axis shaft assembly, a lower surface of the pedal being provided with a pair of upper support frames, the pair of upper support frames being symmetrically disposed at opposite ends of the left-right shaft, both ends of the left-right shaft being provided with first connecting rods, each first connecting rod being hingedly connected at one end to a second connecting rod, the second connecting rod being connected to a compression spring actuating rod, the compression spring actuating rod terminating in a compression spring device, one side of each upper support frame being provided with a second potentiometer for measuring a rotation angle of the left-right shaft, a hollow shaft portion of the second potentiometer being fixedly disposed on the left-right shaft, and a resistive element of the second potentiometer being fixedly disposed on the upper support frame;

A lower plate positioned below the six-axis shaft assembly, an upper surface of the lower plate being provided with a pair of lower support frames for supporting shaft portions of the front-rear shaft, opposite ends of the front-rear shaft each being connected with a torsion spring device, the lower support frames being provided with a first potentiometer for measuring a rotation angle of the front-rear shaft, a hollow shaft portion of the first potentiometer being fixedly disposed on the front-rear shaft, and a resistive element of the first potentiometer being fixedly disposed on the lower support frames;

Wherein both the first potentiometer and the second potentiometer are electrically connected to a main control board;

When a force is applied to a front portion or a rear portion of the pedal, because the pedal is fixedly connected to the upper support frames, the pedal drives the upper support frames to rotate forward or backward about the left-right shaft, the second potentiometer measures a change in the angle through which the upper support frames rotate relative to the left-right shaft, and, after receiving the measured angle data, the main control board converts the angle data into a digital signal and transmits the digital signal to a host device, thereby controlling an in-game object to move forward or backward;

Because the pedal can rotate only forward or backward about the left-right shaft relative to the six-axis shaft assembly, when a force is applied to a left portion or a right portion of the pedal, the pedal remains stationary relative to the six-axis shaft assembly, and the six-axis shaft assembly follows the pedal in rotating about the front-rear shaft relative to the lower support frames, the first potentiometer measures the angle through which the front-rear shaft rotates relative to the lower support frames, and, after receiving the measured angle data, the main control board converts the angle data into a digital signal and transmits the digital signal to the host device, thereby controlling the in-game object to move leftward or rightward.

Preferably, an outer side of each lower support frame is provided with a front fixing seat and a rear fixing seat for fixing the torsion spring device.

Preferably, the lower surface of the pedal is provided with a pair of hanging pieces for fixing the compression spring devices, and the hanging pieces clamp the compression spring devices by bolts.

Preferably, the pedal is rotatable relative to the lower plate about the front-rear shaft and the left-right shaft; when the lower plate contacts the ground, the pedal is in a balanced state under the action of the torsion spring devices and the compression spring devices in the absence of external force; when the pedal is subjected to an external force, the pedal can deflect in a direction corresponding to the applied force, and when the external force is removed, the pedal returns to the balanced state under the action of the torsion spring devices and the compression spring devices.

Preferably, an upper shaft is provided at an upper portion of the six-axis shaft assembly, the upper shaft and one of the front-rear shaft and the left-right shaft form a T-shaped shaft, and first damping devices are provided respectively on front and rear sides of the upper shaft;

A lower shaft is provided at a lower portion of the six-axis shaft assembly, the lower shaft and one of the front-rear shaft and the left-right shaft form a T-shaped shaft, and second damping devices are provided respectively on left and right sides of the lower shaft.

Preferably, the pedal is provided with front-rear limiting holes for mounting first limiting bolts capable of limiting rotation of the upper support frames relative to the six-axis shaft assembly about the left-right shaft, and an upper end portion of the upper shaft is provided with a first threaded hole adapted to the first limiting bolts;

The lower plate is provided with left-right limiting holes for mounting second limiting bolts capable of limiting rotation of the lower support frames relative to the six-axis shaft assembly about the front-rear shaft, and a lower end portion of the lower shaft is provided with a second threaded hole adapted to the second limiting bolts.

Preferably, outward-facing sides of the front-rear limiting holes and the left-right limiting holes are respectively provided with a polygonal upper dustproof groove and a polygonal lower dustproof groove.

Preferably, an upper dustproof cover and a lower dustproof cover are respectively provided at the upper dustproof groove and the lower dustproof groove.

Preferably, a detachable support frame is provided below a front portion of the lower plate.

Preferably, an arcuate limiting plate is provided at a rear end of the pedal.

Preferably, the compression spring device comprises: a first sleeve, an elastic-force pre-adjustment assembly, a third spring, and a first driven member, wherein the first sleeve has a first hollow portion; and the elastic-force pre-adjustment assembly, the third spring, and the first driven member are arranged in the first hollow portion of the first sleeve from top to bottom;

Two ends of the third spring respectively abut against the elastic-force pre-adjustment assembly and the first driven member, and, under a no-external-force condition, the third spring causes the first driven member to be located at a third position within the first sleeve, the elastic-force pre-adjustment assembly being configurable to compress or release the third spring so as to change the magnitude of the elastic force exerted by the third spring on the first driven member;

The compression spring actuating rod is partially sleeved within the first sleeve, one end thereof extends to the exterior of the first sleeve, and the other end thereof is configured to abut against the first driven member so as to transmit force along an axial direction of the first sleeve; when an axial external force applied to the compression spring actuating rod toward the third spring is greater than the elastic force exerted by the third spring on the first driven member, the compression spring actuating rod is capable of driving the first driven member to slide axially along the first sleeve to a fourth position so as to compress the third spring;

Further comprising a first sub-sleeve, wherein a slideway is axially provided in the first sub-sleeve for the compression spring actuating rod to move axially in a reciprocating manner;

When the compression spring actuating rod is subjected to force, one end of the compression spring actuating rod moves axially back and forth within the slideway and, upon entering the slideway of the first sub-sleeve, is configured to abut against the first driven member so as to transmit force.

Preferably, an upper snap-fit assembly and a lower snap-fit assembly are provided on an inner side of a bottom of the first sleeve;

Both the upper snap-fit assembly and the lower snap-fit assembly comprise a second snap ring and a third washer;

The upper snap-fit assembly is disposed above the first sub-sleeve, and the lower snap-fit assembly is disposed below the first sub-sleeve;

The upper snap-fit assembly cooperates with the lower snap-fit assembly so as to constrain the first sub-sleeve on the inner side of the bottom of the first sleeve.

Preferably, a third sealing ring is provided within the first sleeve, an upper surface of the third sealing ring abuts against a lower surface of the first sub-sleeve, and a lower surface of the third sealing ring abuts against an upper surface of the lower snap-fit assembly;

The elastic-force pre-adjustment assembly comprises a first moving member and a first main shaft, the first moving member being sleeved on an outer periphery of the first main shaft and helically connected with the first main shaft, and a lower side of the first moving member abutting against a top of the third spring;

When the first main shaft is rotated by an external force, the first moving member moves axially downward or upward relative to the first main shaft so as to change an expansion/compression state of the third spring;

An outer end portion of the first main shaft is provided with a first adjustment portion.

Preferably, the elastic-force pre-adjustment assembly further comprises a first steel ball, and the first main shaft is provided with a first positioning groove adapted to the first steel ball;

The first steel ball drops into the first positioning groove so as to limit rotation of the first main shaft.

Preferably, the compression spring device further comprises:

A first end cap;

The first end cap having a first assembly region, a bottom of the first assembly region having a first passage, a bottom of the first main shaft extending through the first passage into the first hollow portion of the first sleeve, and the first adjustment portion being exposed outside the first end cap;

A first thrust bearing being provided in the first assembly region, an upper surface of the first thrust bearing abutting against a lower end of the fourth spring, and a lower surface of the first thrust bearing abutting against a bottom of an inner surface of the first assembly region.

Preferably, the torsion spring device comprises:

A second sleeve having a second hollow portion, a second main shaft being arranged in the second hollow portion along an axial direction, and a second moving member, a seventh spring, a fifth spring, a second driven member, and a second driving member being arranged in the second hollow portion of the second sleeve from top to bottom, wherein the second moving member, the seventh spring, the fifth spring, the second driven member, and the second driving member are sleeved on an outer periphery of the second main shaft from top to bottom;

Two ends of the fifth spring respectively abut against the second moving member and the second driven member so as to apply an elastic force thereto; and the second moving member is threadedly connected to the second main shaft and is constrained in cooperation with the second sleeve so as to realize adjustment of an axially reciprocating movement position of the second moving member when the second main shaft rotates;

Tthe second driven member is constrained in cooperation with the second sleeve so as to move axially in a reciprocating manner when driven; and the second driving member is in transmission cooperation with the second driven member through a helical kinematic pair so that, when the second driving member is rotated by an external force in a first direction, the second driving member drives the second driven member to move upward so as to compress the fifth spring, and after the external force is removed, the second driving member returns under the action of the fifth spring in a second direction opposite to the first direction;

An upper end of the second main shaft is provided with a second adjustment portion, and the second adjustment portion is exposed through an upper opening of the second hollow portion of the second sleeve so as to cooperate with an external device to realize rotational adjustment of the second main shaft.

Preferably, the second driven member and the second driving member have, at a bottom end of the helical kinematic pair, an axial-constraint rotational plane perpendicular to an axial direction, the axial-constraint rotational plane being used to constrain axial movement of the second driven member and the second driving member and to provide space for lateral non-driving rotational movement after disengagement of the helical kinematic pair between the second driven member and the second driving member.

Preferably, opposite ends of the second driven member and the second driving member each have a force-applying portion formed outwardly along the axial direction, each force-applying portion having a helical surface formed obliquely along the axial direction, wherein when a first force-applying portion of the second driven member cooperates with a second force-applying portion of the second driving member, corresponding helical surfaces are in surface contact to form the helical kinematic pair, and the axial-constraint rotational planes of the second driven member and the second driving member are located outside bottoms of the helical surfaces of the respective force-applying portions.

Preferably, the second driven member and the second driving member each have two of the force-applying portions uniformly distributed in a circumferential direction, and the two force-applying portions of the second driven member and the two force-applying portions of the second driving member respectively cooperate to form two pairs of the helical kinematic pairs.

Preferably, the second main shaft is assembled and connected with a first limiting assembly at an upper end of the sleeve so as to constrain downward displacement of the second main shaft;

A second limiting assembly is detachably connected to a lower end of the second main shaft, the second limiting assembly being located below the second driving member so that at least part of the second driving member is located within the sleeve.

Compared with the prior art, the foot-operated game controller provided by the present application has the following beneficial effects:

When a forward force is applied to the pedal, the pedal drives the upper support frames to rotate forward relative to the six-axis shaft assembly about the left-right shaft, and the second potentiometer measures the angle through which the upper support frames rotate relative to the six-axis shaft assembly; after the main control board receives the measured angle data, the main control board controls an in-game object to move forward, and the same applies when a backward force is applied to the pedal; if a force is applied to a left portion of the pedal, the pedal remains stationary relative to the six-axis shaft assembly, but the pedal can drive the six-axis shaft assembly to rotate leftward together relative to the lower support frames about the front-rear shaft, and the first potentiometer measures the angle through which the six-axis shaft assembly rotates relative to the lower support frames; after the main control board receives the measured angle data, the main control board controls the in-game object to move leftward, and the same applies when a rightward force is applied to the pedal; in this way, movement of the in-game object can be achieved through the pedal. The player may also customize the function of depressing the pedal. For example, applying a forward force to the pedal may realize actions such as running and jumping. The controller is suitable for players who need to operate many buttons and is especially suitable for players whose hands are inconvenient to use or who have hand disabilities.

By providing the first damping devices or the second damping devices, the elasticity coefficient for force application in the front-rear direction or the left-right direction can be changed, so that players can perceive a clear difference in speed when controlling movement of the in-game object, thereby providing a richer gaming experience.

### BRIEF DESCRIPTION OF THE DRAWINGS

In order to more clearly illustrate the solutions of the present application, the drawings required for use in describing the embodiments are briefly introduced below:

FIG. 1 is a schematic structural view of an embodiment of a foot-operated game controller according to the present application.

FIG. 2 is an exploded view of an embodiment of a foot-operated game controller according to the present application.

FIG. 3 is a first partial structural schematic view of an embodiment of a foot-operated game controller according to the present application.

FIG. 4 is a second partial structural schematic view of an embodiment of a foot-operated game controller according to the present application.

FIG. 5 is a schematic structural view of the six-axis shaft assembly in the foot-operated game controller according to the present application.

FIG. 6 is an assembly schematic view of the six-axis shaft assembly in the foot-operated game controller according to the present application.

FIG. 7 is a schematic view showing cooperation among structures including the six-axis shaft assembly, damping members, first connecting rods, and the like in the foot-operated game controller according to the present application.

FIG. 8 is a static schematic view of the foot-operated game controller according to the present application in a non-actuated state.

FIG. 9 is a static schematic view of the foot-operated game controller according to the present application after an actuation caused by a rearward pedal-depressing operation.

FIG. 10 is a schematic view showing a manner in which a user wears or uses the present device.

FIG. 11 is a schematic view showing a user operating the present device in four directions.

FIG. 12 is a schematic view showing restriction of the degree of freedom in the front-rear direction by means of the first limiting bolt (wherein: the upper left is a view before restriction, the upper right is a half-sectional view before restriction, the lower left is a half-sectional view in which the first threaded hole is aligned and the first limiting bolt is about to be installed, and the lower right is a schematic view after installation of the first limiting bolt).

FIG. 13 is a schematic view showing restriction of the degree of freedom in the left-right direction by means of the second limiting bolt (wherein: the upper left is a view before restriction, the upper right is a half-sectional view before restriction, the lower left is a half-sectional view after cooperation between the second limiting bolt and the second threaded hole is completed, and the lower right is a schematic view after installation of the second limiting bolt).

FIG. 14 is a schematic view after installation of the dustproof covers (wherein the upper figure is a schematic view after installation of the upper dustproof cover, and the lower figure is a schematic view after installation of the lower dustproof cover).

FIG. 15 illustrates a function of inclined placement when the user uses the present device.

FIG. 16 is a demonstration of detachment of the detachable support frame of the present device (wherein the upper figure is a half-sectional view after installation of the detachable support frame, and the lower figure is a half-sectional view showing detachment of the detachable support frame).

FIG. 17 is a schematic view showing the hanging piece on the pedal clamping the compression spring device.

FIG. 18 is a schematic view after a force is applied to the left-front side of the pedal.

FIG. 19 is a sectional structural view of the compression spring device.

FIG. 20 is a sectional structural view of the elastic-force pre-adjustment assembly when the third spring of the compression spring device is in a compressed state.

FIG. 21 is a view showing a state in which the first moving member of the compression spring device moves axially downward.

FIG. 22 is an external half-sectional schematic view of the torsion spring device.

FIG. 23 is a schematic view of an internal structure of the torsion spring device.

FIG. 24 is a schematic structural view of the second sleeve.

FIG. 25 is a schematic structural view of the second main shaft.

FIG. 26 is a schematic structural view when helical surfaces of the second driven member and the second driving member are in contact.

FIG. 27 is a schematic view after axial separation of the second driven member and the second driving member.

FIG. 28 is a schematic structural view of the second driving member.

FIG. 29 is a schematic view showing cooperation between the second main shaft and the second end cap.

FIG. 30 is a schematic structural view of the second moving member.

### DESCRIPTION OF REFERENCE NUMERALS

10—six-axis shaft assembly; 101—front-rear shaft; 102—left-right shaft; 103—up-down shaft; 1031—upper shaft; 10311—first threaded hole; 1032—lower shaft; 10321—second threaded hole; 11—six-axis shaft body; 12—six-axis shaft bearing assembly; 121—first snap ring; 122—first washer; 123—first sealing ring; 124—first sliding bearing sleeve; 125—second sealing ring; 126—second washer; 127—first spring; 201—pedal; 2011—front-rear limiting hole; 2012—upper dustproof groove; 2013—strap slot hole; 202—upper support frame; 203—hanging piece; 204—bolt; 2041—protruding shaft; 205—hook-and-loop fastening strap; 207—arcuate limiting plate; 2071—waist-shaped hole; 301—lower plate; 3011—left-right limiting hole; 3012—lower dustproof groove; 302—lower support frame; 305—front fixing seat; 3051—front fixing seat base; 3052—semicircular plate; 306—rear fixing seat; 31—detachable support frame; 4—compression spring device; 401—first connecting rod; 402—second connecting rod; 403—compression spring actuating rod; 404—first assembly hole; 405—first sleeve; 4051—first guide slot hole; 406—first main shaft; 4061—first positioning groove; 4062—first adjustment portion; 407—first moving member; 408—first steel ball; 409—second spring; 410—third spring; 411—first driven member; 412—first thrust bearing; 413—upper snap-fit assembly; 414—lower snap-fit assembly; 4141—second snap ring; 4142—third washer; 415—first sub-sleeve; 4151—first outer sleeve; 4152—first inner sleeve; 4153—slideway; 416—third sealing ring; 417—first end cap; 4171—first assembly region; 4172—first passage; 418—fourth spring; 419—third snap ring; 420—first housing; 422—first guide member; 5—torsion spring device; 501—second sleeve; 5011—outwardly protruding portion; 5012—second guide slot hole; 5013—third guide slot hole; 502—second end cap; 5021—second locking hole; 503—second housing; 504—third housing; 505—second main shaft; 5051—second positioning groove; 5052—second main shaft thread; 5053—second adjustment portion; 506—second moving member; 5061—third threaded hole; 507—second guide member; 508—third guide member; 509—fifth spring; 510—second driven member; 5103—first helical surface; 5104—first axial movement-constraining rotation plane; 5105—first no-load region; 5106—first force-applying portion; 520—second driving member; 5201—second force-applying portion; 5202—second helical surface; 5203—second axial movement-constraining rotation plane; 5204—second no-load region; 5205—second assembly hole; 5206—first connecting portion; 5207—third assembly hole; 531—fourth snap ring; 532—second thrust bearing; 533—sixth spring; 534—second steel ball; 535—seventh spring; 536—fifth snap ring; 537—third thrust bearing; 601—first potentiometer; 6011—first hollow shaft portion; 6012—first resistive element; 602—second potentiometer; 6021—second hollow shaft portion; 6022—second resistive element; 603—first hanging piece; 604—second hanging piece; 701—first damping device; 7011—first impact head; 7012—first damping body; 702—second damping device; 7021—second impact head; 7022—second damping body; 801—first limiting bolt; 802—second limiting bolt; 803—upper dustproof cover; 804—lower dustproof cover; A—first position; B—second position; C—first hollow portion; D—clamping assembly; E—elastic-force pre-adjustment assembly; F—first limiting assembly; G—second hollow portion; K—fourth position; J—third position.

### DESCRIPTION OF EMBODIMENTS

Unless otherwise defined, all technical and scientific terms used herein have the same meanings as commonly understood by a person skilled in the technical field of the present application. The terms used in the description of the present application are merely for the purpose of describing specific embodiments and are not intended to limit the present application. The terms “comprise” and “have,” and any variations thereof, as used in the description and claims of the present application and in the foregoing description of the drawings, are intended to cover non-exclusive inclusion. Terms such as “first” and “second” in the description and claims of the present application or in the foregoing drawings are used to distinguish different objects, rather than to describe a specific order.

Reference herein to “an embodiment” means that a particular feature, structure, or characteristic described in connection with the embodiment may be included in at least one embodiment of the present application. The appearances of this phrase at various places in the specification do not necessarily refer to the same embodiment, nor do they refer to separate or alternative embodiments mutually exclusive of other embodiments.

It should be noted that, if directions are involved in the embodiments of the present application, the directions are based on the orientation of the human foot shown in FIG. 10 as a reference. For example, “downward” refers to the direction toward the sole of the foot, “forward” refers to the direction toward the toes, “upward” refers to the direction toward the instep of the foot, and “left” refers to the left-hand side as viewed by the user when using and observing the device. The orientations of the device and/or components thereof, including the six-axis shaft assembly 10 and the upper and lower dust covers, are consistent with these directions.

### Embodiment 1

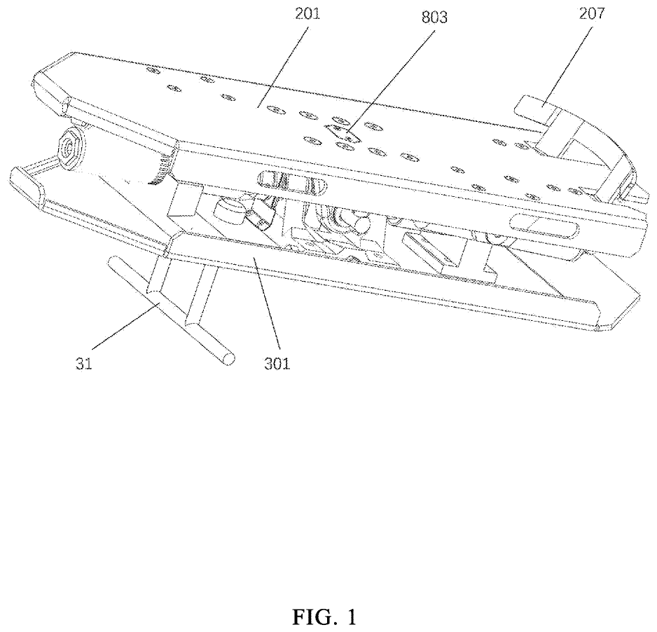

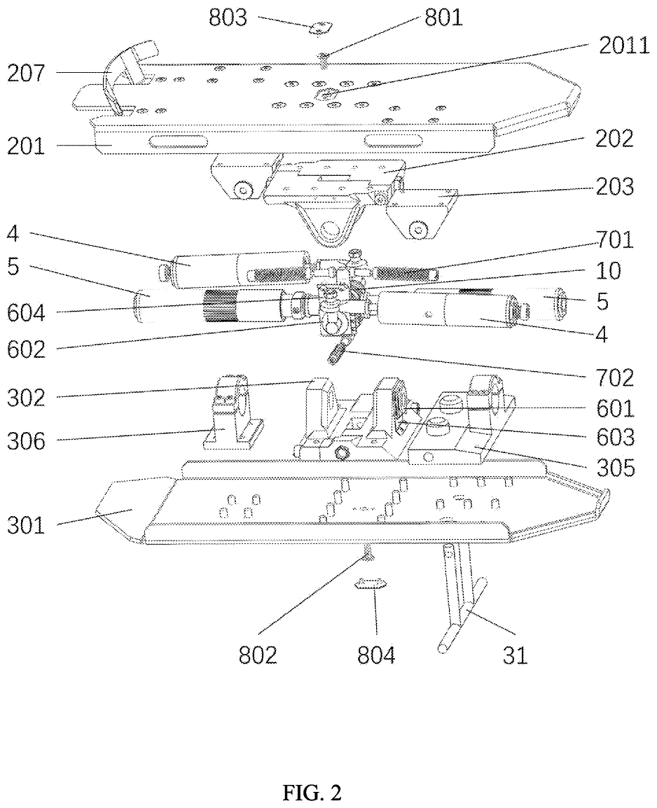

An embodiment of the present application provides a foot-operated game controller. As shown in FIGS. 1-30, the foot-operated game controller comprises:

A six-axis shaft assembly 10, wherein the six-axis shaft assembly 10 comprises a front-rear shaft 101, a left-right shaft 102, and an up-down shaft 103. A pedal 201 is positioned above the six-axis shaft assembly 10. A pair of upper support frames 202 is provided on the lower surface of the pedal 201, and the pair of upper support frames 202 is symmetrically disposed at opposite ends of the left-right shaft 102. Both ends of the left-right shaft 102 are provided with a first connecting rod 401, and each first connecting rod 401 is hingedly connected at one end to a second connecting rod 402. The second connecting rod 402 is connected to a compression spring actuating rod 403, and the compression spring actuating rod 403 terminates in a compression spring device 4. One side of the upper support frame 202 is provided with a second potentiometer 602 for measuring a rotation angle of the left-right shaft 102 relative to the upper support frame 202, wherein a second hollow shaft portion 6021 of the second potentiometer 602 is fixedly disposed on the left-right shaft 102, and a second resistive element 6022 of the second potentiometer 602 is fixedly disposed on the upper support frame 202. A lower plate 301 is positioned below the six-axis shaft assembly 10. The upper surface of the lower plate 301 is provided with a pair of lower support frames 302 for supporting shaft-end portions of the front-rear shaft, and both ends of the front-rear shaft are connected to a torsion spring device 5. The lower support frame 302 is provided with a first potentiometer 601 for measuring a rotation angle of the front-rear shaft 101 relative to the lower support frame 302, wherein a first hollow shaft portion 6011 of the first potentiometer 601 is fixedly disposed on the front-rear shaft 101, and a first resistive element 6012 of the first potentiometer 601 is fixedly disposed on the lower support frame 302. Both potentiometers are electrically connected to a main control board. When a force is applied to a front or rear portion of the pedal 201, because the pedal 201 is fixedly connected to the upper support frames 202, the pedal 201 drives the upper support frames 202 to rotate forward or backward about the left-right shaft 102. The second potentiometer 602 measures a change in the angle through which the upper support frames 202 rotate relative to the left-right shaft 102 and outputs a corresponding electrical signal. After receiving the measured angle data, the main control board converts the angle data into a digital signal and transmits the digital signal to a host device, thereby controlling an in-game object to move forward or backward.

During use, the user places the left foot or right foot on the pedal 201, as shown in FIG. 10. The pedal has a length of about 30 cm and a width of about 12 cm, matching the foot sizes of most people. The user may adjust the position of the arcuate limiting plate 207 relative to the pedal 201 to support the heel, and may also use the hook-and-loop fastening strap 205 as needed to adjust the fit between the shoe and the pedal 201. Of course, for convenience, use of the hook-and-loop fastening strap 205 is not mandatory. The user uses ankle force to depress the pedal 201 in a certain direction so that the pedal 201 deflects in that direction, thereby controlling the in-game object.

In one implementation, the torsion spring device 5 and the compression spring device 4 of the present application can simulate force feedback in a real-world scenario, thereby optimizing operating feel and enhancing game immersion. The torsion spring device 5 and the compression spring device 4 can each independently adjust elastic force so as to meet the needs of different players and different game types.

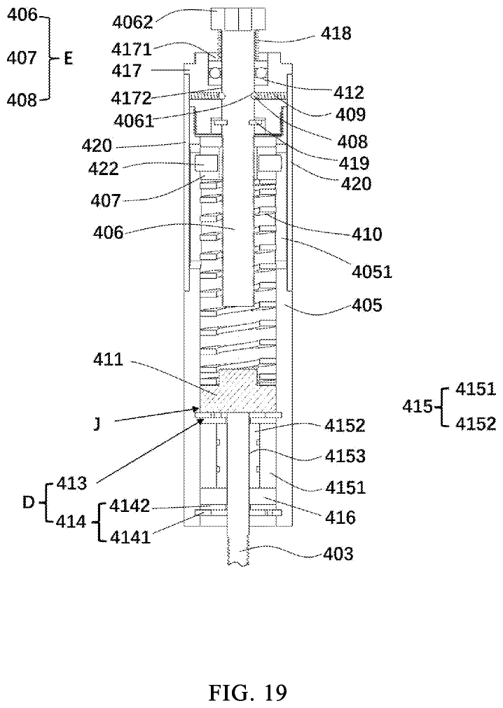

As shown in FIGS. 19 to 21, the compression spring device 4 comprises a first housing 420 and a first sleeve 405. The first housing 420 is sleeved over the exterior of the first sleeve 405 so as to prevent dust from entering the first sleeve 405. The first sleeve 405 has a first hollow portion C. Both ends of the first sleeve 405 are open, and the first hollow portion C communicates with the openings at both ends.

The compression spring device further comprises an elastic-force pre-adjustment assembly E, a third spring 410, and a first driven member 411 disposed in the first sleeve 405, wherein two ends of the third spring 410 respectively abut against the elastic-force pre-adjustment assembly E and the first driven member 411.

The elastic-force pre-adjustment assembly E is adjustable to compress the third spring 410 such that the third spring 410 exerts an elastic force on the first driven member 411, and the magnitude of the elastic force varies according to the adjustment amount of the elastic-force pre-adjustment assembly E.

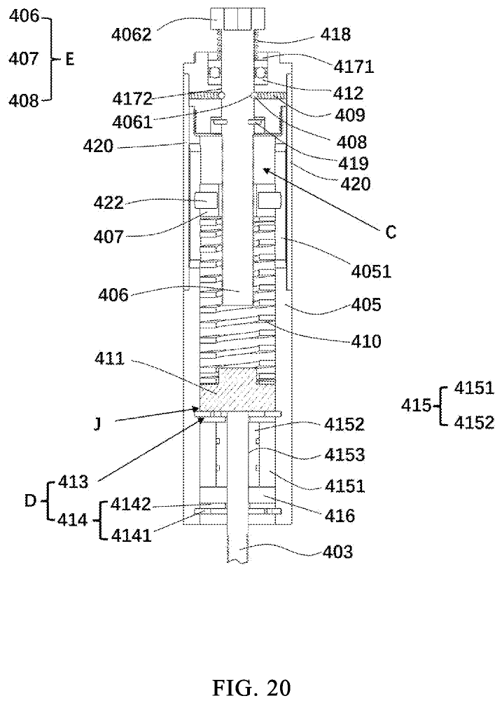

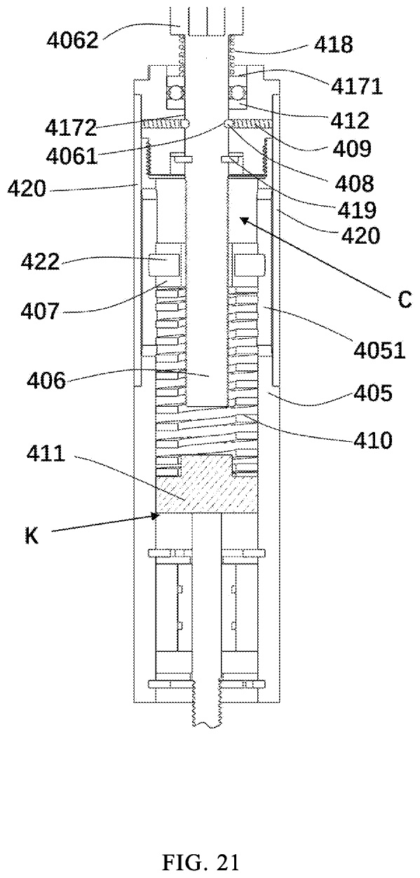

The other end of the first driven member 411 abuts against the compression spring actuating rod 403. The compression spring actuating rod 403 is partially sleeved in the first sleeve 405, and one end thereof extends to the exterior of the first sleeve 405. The other end of the first driven member 411 can abut against the compression spring actuating rod 403 so as to transmit force in the axial direction of the first sleeve 405. When an axial external force acting on the compression spring actuating rod 403 toward the third spring 410 is greater than the elastic force exerted by the third spring 410 on the first driven member 411, the compression spring actuating rod 403 can drive the first driven member 411 to slide axially along the first sleeve 405 to a fourth position K so as to compress the third spring 410, changing, for example, from the state shown in FIG. 20 to the state shown in FIG. 21.

It should be understood that, during movement of the first driven member 411 axially along the first sleeve 405 to the fourth position K, the axial external force applied to the compression spring actuating rod 403 toward the third spring 410 is greater than the elastic force exerted by the third spring 410 on the first driven member 411 until force equilibrium is reached. In this way, the user can apply the compression spring device 4 with adjustable elastic force to applications in which different pushing forces are required to move a corresponding member, thereby satisfying use requirements under different loading scenarios.

In particular, during use, when the elastic-force pre-adjustment assembly E is controlled, the third spring 410 can be pre-compressed or released in advance so as to change the magnitude of the elastic force exerted by the third spring 410 on the first driven member 411.

In actual use, the elastic-force pre-adjustment assembly E is controlled such that the elastic-force pre-adjustment assembly E pre-compresses or releases the third spring 410. Specifically, the elastic-force pre-adjustment assembly E comprises a first moving member 407, a first steel ball 408, and a first main shaft 406. The outward-facing end surface of the first main shaft 406 is provided with a hexagonal hole for insertion of a hexagonal screwdriver. The user can control the first main shaft 406 to rotate by turning the screwdriver. When the first main shaft 406 rotates in a forward direction, the first moving member 407, which is sleeved on the outer periphery of the first main shaft 406 and is helically connected thereto, moves axially downward relative to the first main shaft 406, as shown by the change from the state in FIG. 19 to the state in FIG. 20. It should be noted that, because two first guide members 422 in the radial direction of the first moving member 407 respectively abut against two first guide slot holes 4051 on the first sleeve 405, and positions on the first sleeve 405 where the first guide members 422 of the first moving member 407 abut are provided with limiting slots, namely the first guide slot holes 4051, the limiting slots, i.e., the first guide slot holes 4051, extend in the axial direction of the first sleeve 405. When the first moving member 407 moves axially along the first sleeve 405, the first guide members 422 fixed on the first moving member 407 are restricted by the first guide slot holes 4051. Therefore, the first moving member 407 can move only upward or downward in the axial direction along the first sleeve 405.

In addition, because the lower surface of the first moving member 407 abuts against the top of the third spring 410, when the first main shaft 406 rotates in the forward direction, as shown in FIG. 20, the first moving member 407 moves axially downward so as to compress the third spring 410. The spring force generated by compression of the third spring 410 is transmitted to the first driven member 411, thereby forming an elastic force acting on the compression spring actuating rod 403.

Conversely, when the first main shaft 406 rotates in the reverse direction, the first moving member 407 moves axially upward relative to the first main shaft 406, i.e., the states of the first moving member 407 and the third spring 410 change from the state shown in FIG. 20 to the state shown in FIG. 19, so as to release the third spring 410, thereby reducing the elastic force exerted by the third spring 410 on the first driven member 411 and the compression spring actuating rod 403.

For example, according to the elasticity formula F=kx, where F is elastic force, k is the elastic coefficient of the material, and x is the amount of spring deformation, i.e., the change in spring height. In an adjustable elastic-force adjustment device, k, i.e., the elastic coefficient, is determined by the material properties of the third spring 410 itself, and therefore k is fixed. As the first moving member 407 moves axially downward along the first sleeve 405, the deformation amount x becomes larger and larger. According to the formula F=kx, the elastic force F correspondingly exhibits an increasing trend as the first moving member 407 moves axially downward. Therefore, by controlling forward rotation of the first main shaft 406, the first moving member 407 can be caused to move further axially downward, thereby increasing the force exerted by the third spring 410 on the first driven member 411. Conversely, by controlling reverse rotation of the first main shaft 406, the first moving member 407 can be caused to move axially upward so as to reduce the force exerted by the third spring 410 on the first driven member 411. Therefore, adjustment of the elastic force of the third spring 410 can be achieved by controlling the first main shaft 406.

When not in use, i.e., under a no-external-force condition, the third spring 410 causes the first driven member 411 to be located at a third position J within the first sleeve 405, as shown in FIG. 19. At this time, the third spring 410 does not undergo telescopic deformation due to the compression spring actuating rod 403.

After the elastic force has been pre-adjusted to a suitable value, the adjustable elastic-force device needs to maintain that elastic force in a fixed state. Further, the elastic-force pre-adjustment assembly E further comprises a first steel ball 408, and the first main shaft 406 cooperating with the first steel ball 408 is provided with a first positioning groove 4061. The first steel ball 408 falls into the first positioning groove 4061 so as to restrict rotation of the first main shaft 406.

During use, the first main shaft 406 is twisted by an external force or a tool such as a screwdriver. After the first main shaft 406 has been rotated such that the first moving member 407 moves downward to compress the third spring 410 and generate the desired elastic force, the first main shaft 406 is further rotated until the first positioning groove 4061 thereof is aligned with the first steel ball 408, so that the first steel ball 408 can fall into the first positioning groove 4061 and prevent further rotation of the first main shaft 406, thereby preventing further movement of the first moving member 407.

The first steel ball 408 is disposed in a first end cap 417 mounted at the top of the first sleeve 405. Specifically, the first end cap 417 has a first assembly region 4171, which is a recess recessed inward from the surface of the first end cap 417. The top of the first assembly region 4171 is open, and the bottom of the first assembly region 4171 is provided with a first passage 4172, which communicates with the first hollow portion C. During assembly, the bottom of the first main shaft 406 extends through the first passage 4172 into the first hollow portion C of the first sleeve 405. After the first main shaft 406 passes through the first passage 4172, the first adjustment portion 4062 is exposed outside the opening; that is, the first adjustment portion 4062 of the first main shaft 406 is exposed outside the first end cap 417, so that the user can perform a twisting operation on the first adjustment portion 4062 of the first main shaft 406.

The first steel ball 408 is specifically disposed on the inner wall of the first passage 4172. In this embodiment, the first steel ball 408 is a spherical positioning bead. A corresponding mounting groove is formed inside the first passage 4172 to mount the positioning bead. A portion of the positioning bead is accommodated in the mounting groove, and another portion of the positioning bead is exposed on the inner wall surface of the first passage 4172. When the first main shaft 406 accommodated within the first passage 4172 is rotated until its first positioning groove 4061 is aligned with the positioning bead, the positioning bead falls into the first positioning groove 4061. A second spring 409 abuts against the positioning bead and applies a radially inward elastic force thereto, thereby positioning the first main shaft 406 and preventing the first main shaft 406 from shifting position in the absence of external force.

A first thrust bearing 412 is disposed in the first assembly region 4171. An upper surface of the first thrust bearing 412 abuts against a lower end of the fourth spring, and a lower surface of the first thrust bearing 412 abuts against the bottom of the inner surface of the first assembly region 4171. When the first main shaft 406 is rotated by an external force, the first thrust bearing 412 supports rotation of the first main shaft 406 while bearing axial load and limiting axial displacement of the first main shaft 406.

A fourth spring 418 is disposed between the top of the first thrust bearing 412 and the underside of the first adjustment portion 4062, so that when the adjustable elastic-force adjustment device needs to be disassembled, the first adjustment portion 4062 can be pressed axially to compress the fourth spring 418, thereby exposing a third snap ring 419 from a lower groove of the first end cap 417, facilitating removal of the third snap ring 419 with snap-ring removal tools and thereby further enabling disassembly of the elastic-force pre-adjustment assembly E and the first end cap 417. In addition, the fourth spring 418 can also support the first adjustment portion 4062, preventing the first main shaft 406 from moving axially downward in the absence of external force.

A third snap ring 419 is disposed between the first end cap 417 and the first moving member 407. The third snap ring 419 is disposed on the outer periphery of the first main shaft 406 and is used to prevent the first main shaft 406 from moving axially upward. In summary, the third snap ring 419 cooperates with the fourth spring 418 to constrain the first main shaft 406 at the top of the first sleeve 405, effectively preventing the first main shaft 406 from moving axially upward or downward in the first passage 4172 when no external force is applied.

A first sub-sleeve 415 is disposed in the first sleeve 405. A slideway 4153 is axially provided in the first sub-sleeve 415 for axial reciprocating movement of the compression spring actuating rod 403. When the compression spring actuating rod 403 is subjected to force, an end of the compression spring actuating rod 403 reciprocates axially in the slideway 4153, and upon entering the slideway 4153 in the first sub-sleeve 415, the end can abut against the first driven member 411 so as to transmit force.

During use, when the portion of the compression spring actuating rod 403 exposed outside the first sleeve 405 is subjected to force, the compression spring actuating rod 403 slides axially in the slideway 4153 until it abuts against the first driven member 411, so that the first driven member 411 can compress the third spring 410. The arrangement of the slideway 4153 can prevent the compression spring actuating rod 403 from moving radially during sliding and thereby preventing radial displacement.

The first sub-sleeve 415 has a split structure formed by a first outer sleeve 4151 and a first inner sleeve 4152. The first outer sleeve 4151 is sleeved over the outer periphery of the first inner sleeve 4152. With this design, the first outer sleeve 4151 is used for axial positioning, and the first inner sleeve 4152 may be a linear bearing or a bushing. After long-term use, the first inner sleeve 4152 will wear, and the split design of the first outer sleeve 4151 and the first inner sleeve 4152 facilitates replacement of the worn first inner sleeve 4152.

At least two groups of clamping assemblies D are provided on an inner side of the bottom of the first sleeve 405, and each group of clamping assemblies D comprises a third washer 4142 and a second snap ring 4141. One group of the clamping assemblies D is disposed above the first sub-sleeve 415 and is defined as an upper snap-fit assembly 413, and another group of the clamping assemblies D is disposed below the sub-sleeve and is defined as a lower snap-fit assembly 414. The upper snap-fit assembly 413 cooperates with the lower snap-fit assembly 414 to constrain the first sub-sleeve 415 on the inner side of the bottom of the first sleeve 405.

It should be understood that, when the user depresses the pedal 201, the compression spring actuating rod 403 moves in the slideway 4153 when an external force is applied, and friction is generated between the surface of the compression spring actuating rod 403 and the inner wall of the slideway 4153, causing the first sub-sleeve 415 to move axially along with the axial movement of the compression spring actuating rod 403. The upper snap-fit assembly 413 and the lower snap-fit assembly 414 constrain the first sub-sleeve 415 on the inner side of the bottom of the first sleeve 405, thereby effectively preventing the first sub-sleeve 415 from moving axially.

In addition, when the compression spring actuating rod 403 does not abut against the first driven member 411, because the first moving member 407 exerts a compressive action on the third spring 410, the first driven member 411 tends to move downward, and the clamping assembly D can block the first driven member 411 from moving further downward.

A third sealing ring 416 is disposed in the first sleeve 405. An upper surface of the third sealing ring 416 abuts against a lower surface of the first sub-sleeve 415, and a lower surface of the third sealing ring 416 abuts against an upper surface of the lower snap-fit assembly 414. When the compression spring actuating rod 403 reciprocates in the slideway 4153, the third sealing ring 416 can prevent external dust from entering the interior spring structure.

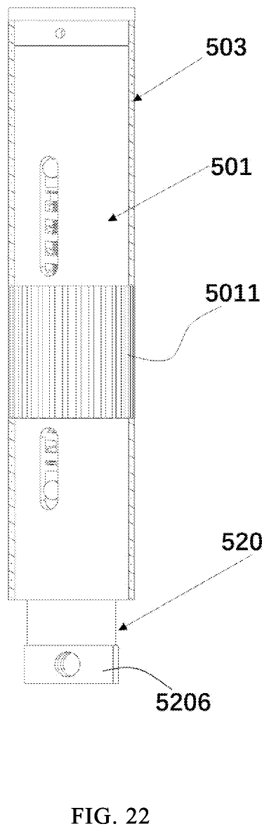

As shown in FIGS. 22 to 30, the torsion spring device 5 comprises a second sleeve 501, a second main shaft 505, a second moving member 506, a fifth spring 509, a second driven member 510, a second driving member 520, and a seventh spring 535 associated with a first limiting assembly F. The seventh spring 535, the second moving member 506, the fifth spring 509, the second driven member 510, and the second driving member 520 are arranged from top to bottom in a second hollow portion G of the second sleeve 501 and are sleeved from top to bottom on the outer periphery of the second main shaft 505. The seventh spring 535 functions as part of the first limiting assembly F described below, while the fifth spring 509 applies elastic force between the second moving member 506 and the second driven member 510.

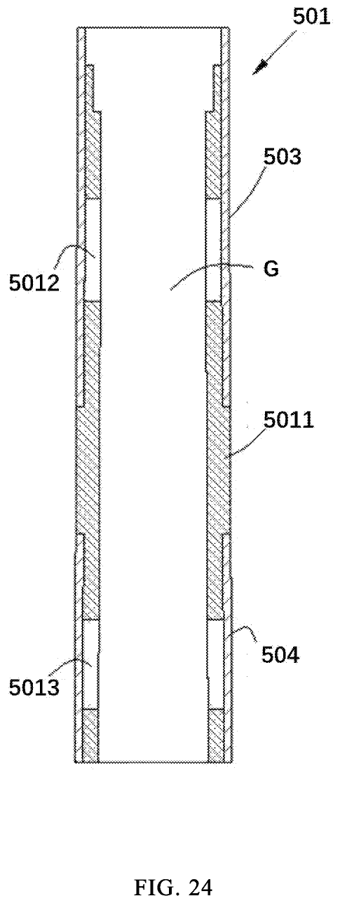

As shown in FIG. 24, the second sleeve 501 is a hollow structure having a second hollow portion G, and upper and lower ends of the second hollow portion G are of an open design, i.e., including an upper-end opening and a lower-end opening. Preferably, the second sleeve 501 is a cylindrical sleeve structure. In addition, the torsion spring device of the present application needs to be mounted at a specific position, for example, fixed on an assembly plate. To facilitate assembly, in some embodiments the second sleeve 501 is designed as a stepped structure. Specifically, as shown in FIGS. 22 and 24, an outwardly protruding portion 5011 is provided at the middle position of the second sleeve 501, and both ends are small-end portions. During assembly, a clamp structure clamps the outwardly protruding portion 5011 so as to fixedly mount the entire torsion spring device. To ensure the strength of the entire torsion spring device, the second sleeve 501 is preferably made of metal material, such as stainless steel, iron, copper, or aluminum alloy. To ensure the mutual biting force during clamp fixing and thus ensure installation stability, the outer surface of the outwardly protruding portion 5011 is designed as an anti-slip tooth structure. Specifically, rack-like structures extending in the axial direction are provided on the outer surface of the outwardly protruding portion 5011. In this way, during fixing, the clamp can engage more tightly with these rack-like structures.

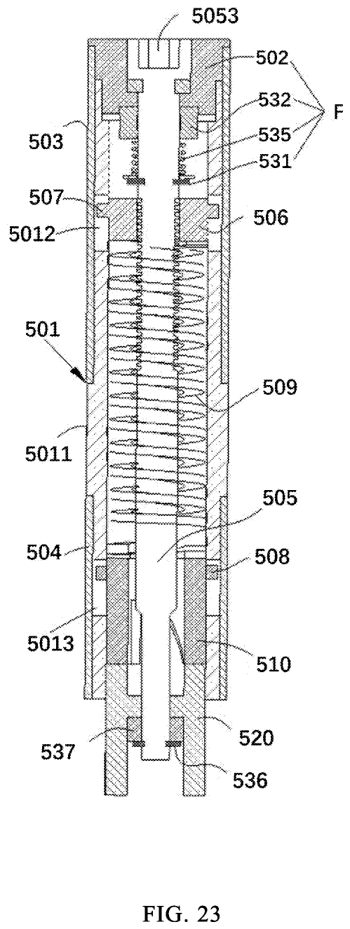

As shown in FIG. 23, the second main shaft 505 is assembled and connected with the first limiting assembly F at an upper end of the second sleeve 501 so as to restrain downward displacement of the second main shaft 505. A fifth snap ring 536 is detachably connected to a lower end of the second main shaft 505, and the fifth snap ring 536 is located below the second driving member 520 so that at least part of the second driving member 520 is located within the second sleeve 501.

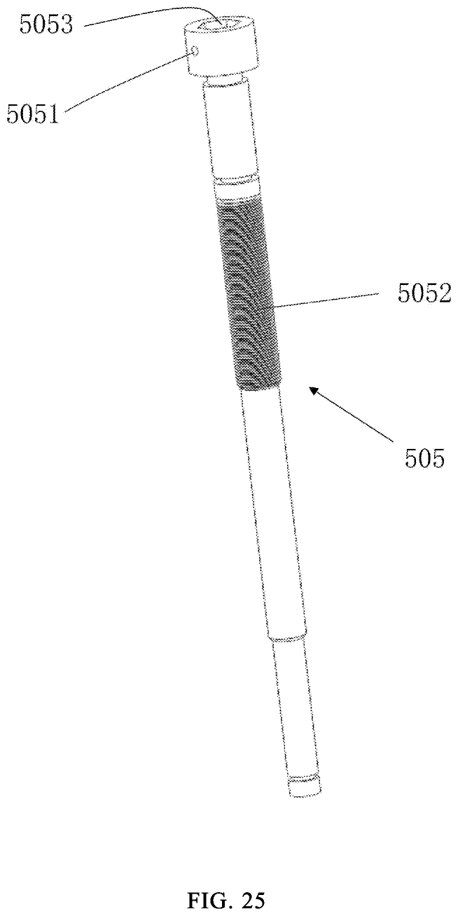

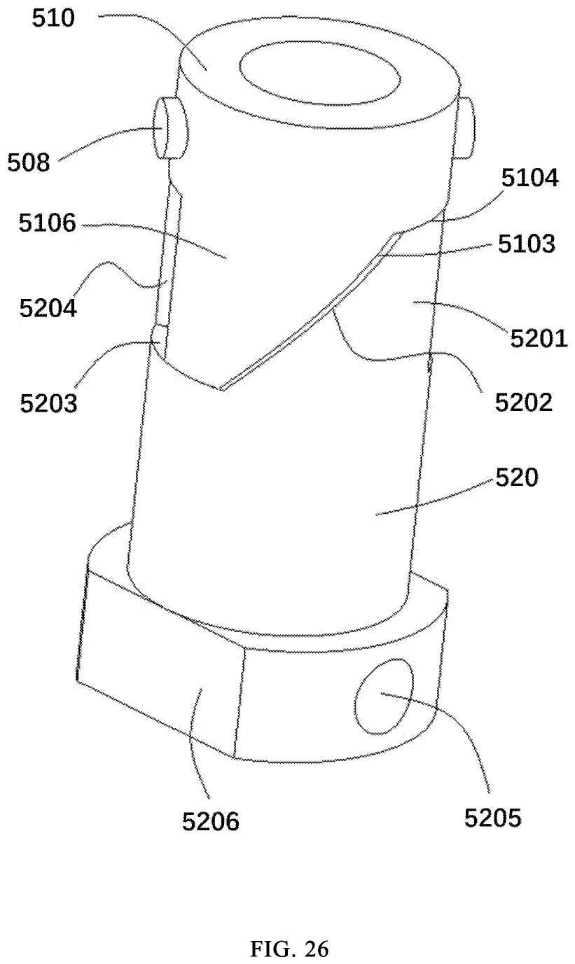

As shown in FIG. 25, the second main shaft 505 as a whole has a stepped configuration including an upper portion, a middle portion, and a lower portion. The outer diameter of the upper portion, i.e., the second adjustment portion 5053, is greater than that of the middle portion, and the outer diameter of the middle portion is greater than that of the lower portion, although the structure is not limited thereto and any suitable shape of the second main shaft 505 may be used. As shown in FIG. 23, the first limiting assembly F comprises a second end cap 502. The second end cap 502 has a stepped through hole, an upper end of which is larger than a lower end thereof. The second adjustment portion 5053 of the second main shaft 505 is arranged in the upper-end portion of the stepped through hole, and the middle portion of the second main shaft 505 extends downward after passing through the lower-end portion of the through hole of the second end cap 502. The second end cap 502 has a stepped outer shape, an upper portion of which has an outer dimension greater than the size of the upper-end opening of the second hollow portion G of the second sleeve 501, and a lower portion of which matches the shape and size of the second hollow portion G, so that the second end cap 502 is inserted into the second hollow portion G and restrains the second main shaft 505 from axial downward movement. In order to ensure that the second main shaft 505 and the second end cap 502 can be fixed together and to prevent the second main shaft 505 from disengaging upward, the first limiting assembly F further comprises the seventh spring 535 and a fourth snap ring 531. The fourth snap ring 531 is detachably assembled with the second main shaft 505. The seventh spring 535 is sleeved on the outer periphery of the second main shaft 505 and is located between the fourth snap ring 531 and a second thrust bearing 532. The second thrust bearing 532 is sleeved on the second main shaft 505, with an upper end abutting against the second end cap 502 and a lower end abutting against the seventh spring 535. By this arrangement, the seventh spring 535 applies an axial downward force to the fourth snap ring 531 and thus applies a downward force to the second main shaft 505, thereby ensuring stable assembly of the second main shaft 505 and the second end cap 502 and preventing easy disengagement.

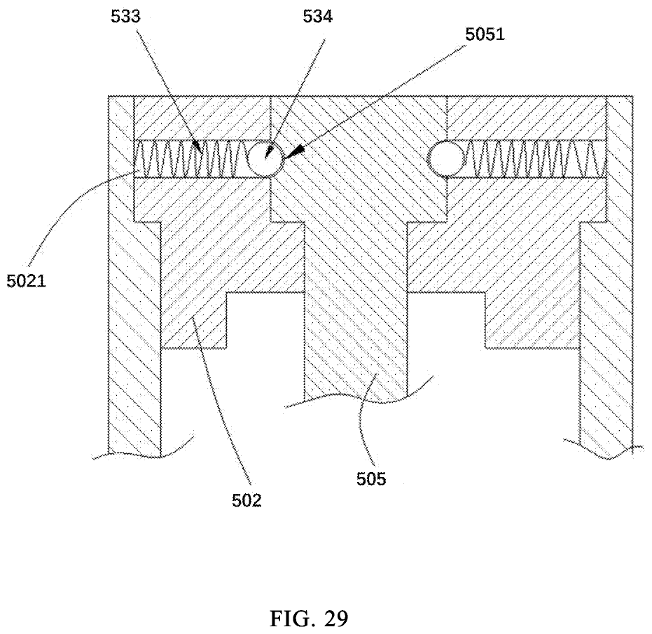

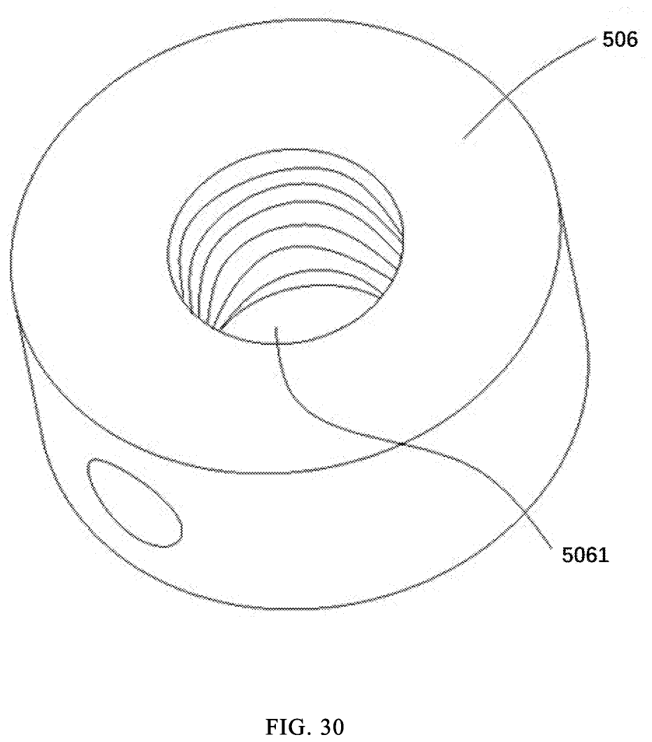

As shown in FIG. 29, this figure illustrates a schematic assembly view of the second end cap 502 and the second main shaft 505. Specifically, the second end cap 502 is radially provided with a second locking hole 5021, in which a sixth spring 533 and a second steel ball 534 are disposed, and an outer side of the second main shaft 505 that cooperates with the hole of the second end cap 502 is provided with a second positioning groove 5051. During assembly, both the sixth spring 533 and the second steel ball 534 are disposed in the second locking hole 5021, and under the elastic force of the sixth spring 533, the second steel ball 534 is partially engaged at the second positioning groove 5051. In this way, the second steel ball 534 partially falls into the second positioning groove 5051 and partially remains within the second locking hole 5021, thereby locking the second main shaft 505. That is, when no external force is applied, or when the external force does not exceed a predetermined force, the second main shaft 505 does not rotate. When the second main shaft 505 is rotated under force, the second steel ball 534 is squeezed by the second main shaft 505 into the second locking hole 5021, so that the second main shaft 505 can continue to rotate to compress the fifth spring 509 or release the fifth spring 509. After the external force is removed, the second steel ball 534 is reset to the second positioning groove 5051 under the action of the sixth spring 533, thereby achieving rotational locking of the second main shaft 505. Of course, it should be understood that the torque generated by the fifth spring 509 is insufficient to drive the second main shaft 505 to overcome the restraint of the sixth spring 533. It should also be understood that, in this solution, a plurality of the second positioning grooves 5051 are provided on the circumferential side of the second end cap 502 in the circumferential direction, so that at different rotational angles the second steel ball 534 can fall into different second positioning grooves 5051 to achieve locking. Of course, in addition, the second steel ball 534 may for example be a friction member. After assembly, the friction member frictionally contacts the outer circumferential side of the second end cap 502 so as to constrain rotation of the second main shaft 505. In other embodiments, the sixth spring 533 and the second steel ball 534 may also be omitted, and instead the second end cap 502 may frictionally contact the outer circumferential side of the second main shaft 505 to resist the torque generated by the fifth spring 509, thereby preventing rotation when no external force is applied or when the external force is insufficient.

As shown in FIGS. 23 and 25, the second moving member 506 is in threaded connection with the second main shaft 505 and is in constrained fit with the second sleeve 501 so as to realize axial reciprocating movement during rotation of the second main shaft 505. Specifically, a second main shaft thread 5052 is provided on the outer periphery of an upper half of the middle portion of the second main shaft 505. As shown in FIG. 30, the second moving member 506 is provided with a third threaded hole 5061, and an internal thread is provided in the third threaded hole 5061. During assembly, the third threaded hole 5061 of the second moving member 506 is sleeved on the second main shaft thread 5052 to achieve threaded connection. A second guide slot hole 5012 extending in the axial direction is provided on the second sleeve 501. A second guide member 507 is detachably connected to the outer periphery of the second moving member 506. The second guide member 507 is located at the second guide slot hole 5012 and is circumferentially constrained by abutting contact, such that the second guide member 507 can move only up and down along the second guide slot hole 5012. That is, the second main shaft 505, the second moving member 506, the second guide member 507, and the second guide slot hole 5012 of the second sleeve 501 constitute a threaded screw-rod slider structure. When the second main shaft 505 rotates, the limiting action of the second guide slot hole 5012 of the second sleeve 501 on the second guide member 507 causes the second moving member 506 to move up and down in the axial direction. When the second moving member 506 moves downward, the fifth spring 509 is further compressed, thereby increasing the elastic force generated by the fifth spring 509; when the second moving member 506 moves upward, the fifth spring 509 is released, thereby reducing the elastic force of the fifth spring 509. In addition, in order to prevent accumulation of dust, impurities, and the like at the second guide slot hole 5012, a second housing 503 is sleeved around the outer periphery of the region where the second guide slot hole 5012 is provided.

As shown in FIG. 23, opposite ends of the fifth spring 509 respectively abut against the second moving member 506 and the second driven member 510 so as to apply spring force thereto. Specifically, in the present technical solution, the fifth spring 509 is always in a compressed state, or is exactly in a free state when the second moving member 506 has moved upward to its uppermost position and the second driven member 510 is located at its lowermost position. That is, except when the second moving member 506 has moved upward to the uppermost position and the second driven member 510 is located at the lowermost position, at which time the fifth spring 509 is in a free state, the fifth spring 509 is in a compressed state at all other positions. The spring force generated by the fifth spring 509 exerts an upward force on the second moving member 506 and a downward force on the second driven member 510.

In this embodiment, the second driven member 510 is constrainedly fitted with the second sleeve 501 so as to reciprocate in the axial direction when driven. That is, the second driven member 510 can only reciprocate in the axial direction. In detail, as shown in FIG. 23, a third guide member 508 is detachably connected to the outer side of the second driven member 510, and the lower portion of the second sleeve 501 is provided with a third guide slot hole 5013 extending in the axial direction. The third guide member 508 is located in the third guide slot hole 5013 and circumferentially abuts against the sidewall defining the third guide slot hole 5013. In this way, when the second driven member 510 is subjected to force, it can only move axially. In addition, in order to prevent the accumulation of dust, impurities, and the like at the third guide slot hole 5013, a third outer shell 504 is sleeved around the outer periphery of the region where the third guide slot hole 5013 is provided.

It should be understood that the second driving member 520 and the second driven member 510 are in transmission fit through a helical kinematic pair, so that when the second driving member 520 is rotated by an external force in a first direction, the second driven member 510 is driven to move upward to compress the fifth spring 509, and after the external force is removed, the second driving member 520 returns in a second direction opposite to the first direction under the action of the fifth spring 509. Specifically, when the second driving member 520 is rotated under force in the first direction (for example, leftward as shown in FIG. 23), the second driving member 520 drives the second driven member 510 axially upward away from the second driving member 520, that is, the second driven member 510 is driven to move upward, and during the movement the fifth spring 509 is further compressed. After the external force acting on the second driving member 520 is removed, the fifth spring 509 returns in the direction of restoring spring force, with the amount of compression decreasing, that is, the fifth spring 509 rebounds and drives the second driven member 510 downward. When the second driven member 510 moves downward, it drives the second driving member 520 to rotate in the second direction and return to the initial state. During the downward movement of the second driven member 510, the action of the helical kinematic pair between the second driving member 520 and the second driven member 510 causes the second driving member 520 to rotate in the second direction until the fifth spring 509 is fully restored to the initial position. In this way, one torque stroke is achieved.

In addition, as shown in FIG. 23, the fifth snap ring 536 may, for example, be a snap ring plate. The fifth snap ring 536 is detachably snapped onto the lower portion of the second main shaft 505, and the upper end surface of the fifth snap ring 536 abuts against the second driving member 520 so as to axially constrain the second driving member 520 and prevent the second driving member 520 from disengaging from the second main shaft 505 under the spring force generated by the fifth spring 509. In one specific embodiment, a third thrust bearing 537 is disposed between the second driving member 520 and the fifth snap ring 536, the upper end of the third thrust bearing 537 abutting against the second driving member 520 and the lower end thereof abutting against the fifth snap ring 536.

As shown in FIGS. 22 and 23, the upper end of the second main shaft 505 is provided with a second adjustment portion 5053, which is exposed through the upper opening of the second hollow portion G of the second sleeve 501 for cooperating with an external device to rotationally adjust the second main shaft 505.

It should be understood that the second adjustment portion 5053 is intended for cooperation with an external tool. That is, a tool is engaged with the second adjustment portion 5053 to rotate the second main shaft 505 by a desired angle. For example, when the second main shaft 505 is reversely rotated (for example, rightward as shown in FIG. 23), the second moving member 506 moves downward, and at this time the fifth spring 509 is further compressed, so that the spring force generated by the fifth spring 509 increases. Thereafter, when the second driving member 520 needs to be driven to rotate in the first direction (leftward as shown in FIG. 23), a greater torque is required. Similarly, when the second main shaft 505 is forwardly rotated (leftward as shown in FIG. 23), the second moving member 506 moves upward, and at this time the compression amount of the fifth spring 509 decreases, so that the generated spring force decreases; accordingly, when the second driving member 520 needs to be rotated in the first direction (leftward as shown in FIG. 23), the required torque becomes smaller. Through this solution, torque adjustment of the spring torque device is achieved. That is, the second main shaft 505 can be adjusted forwardly or reversely according to the usage needs of different persons. When the spring torque device is applied to a game controller, for adults, reverse adjustment may be performed to increase the torque so as to satisfy adults' force-applying habits. Similarly, if the user is a child, the second main shaft 505 may be adjusted forwardly to reduce the torque, thereby satisfying the force-applying habits of children. In other words, ergonomic force-applying habits are satisfied. In general, a person requiring greater torque may reversely adjust the second main shaft 505, whereas a person requiring smaller torque may forwardly adjust the second main shaft 505.

Specifically, as shown in FIGS. 22 and 23, the second adjustment portion 5053 is a slot recessed inwardly in the top end surface of the second main shaft 505. The slot may, for example, be a cross-shaped slot for use with a Phillips screwdriver; the slot may also be a hexagonal slot for use with a hex key. Of course, the slot may have any suitable shape to match different tools. Importantly, the second adjustment portion 5053 is exposed, thereby facilitating insertion of a tool for cooperative adjustment.

The second adjustment portion 5053 may be recessed within the second hollow portion G of the second sleeve 501; alternatively, it may extend axially to the exterior of the second sleeve 501. For example, the second adjustment portion 5053 may be a protruding structure extending beyond the second sleeve 501. Such a solution also facilitates gripping the protruding structure with a tool to achieve forward and reverse adjustment.

The second driven member 510 and the second driving member 520 are provided, at the bottom end of the helical kinematic pair, with an axially constraining rotational plane perpendicular to the axial direction. The axially constraining rotational plane is configured to constrain axial movement of the second driven member 510 and the second driving member 520 and to provide, after disengagement of the helical kinematic pair therebetween, space for lateral non-transmission rotational movement. Here, with respect to the second driven member 510, the term “bottom end” refers to the bottom in the direction away from the second driving member 520; similarly, with respect to the second driving member 520, the term “bottom end” refers to the bottom in the direction away from the second driven member 510. That is, when the second driven member 510 and the second driving member 520 move to a state in which they are closest to each other, if they continue to rotate further, the helical kinematic pair will disengage. Thereafter, if the second driving member 520 continues rotating in the second direction, shown in FIG. 23 as the rightward direction, the second driving member 520 no longer exerts an axial force on the second driven member 510, and even if the second driving member 520 rotates further, it will not drive the second driven member 510 to move axially. Such a configuration facilitates controlling the movement distance of the second driven member 510 and adapting to requirements for graded and partitioned force application. Therefore, in the present application, the “space for lateral non-transmission rotational movement after disengagement of the helical kinematic pair between the second driven member 510 and the second driving member 520” means that, when the second driving member 520 has moved in the second direction to a position where the two are closest to each other, and the second driving member 520 is further rotated in the second direction, the second driving member 520 no longer applies an axial force to the second driven member 510 through the helical kinematic pair. Subsequent further rotation will therefore not drive axial movement of the second driven member 510, while the second driving member 520 itself remains capable of further rotation in the second direction. During this rotation, the second driving member 520 does not cause the second driven member 510 to rotate, because the second driven member 510 is capable only of axial movement. In the present application, the process in which the second driving member 520 further rotates in the second direction after entering the axially constraining rotational plane, without causing axial movement of the second driven member 510, is defined as a no-load region.

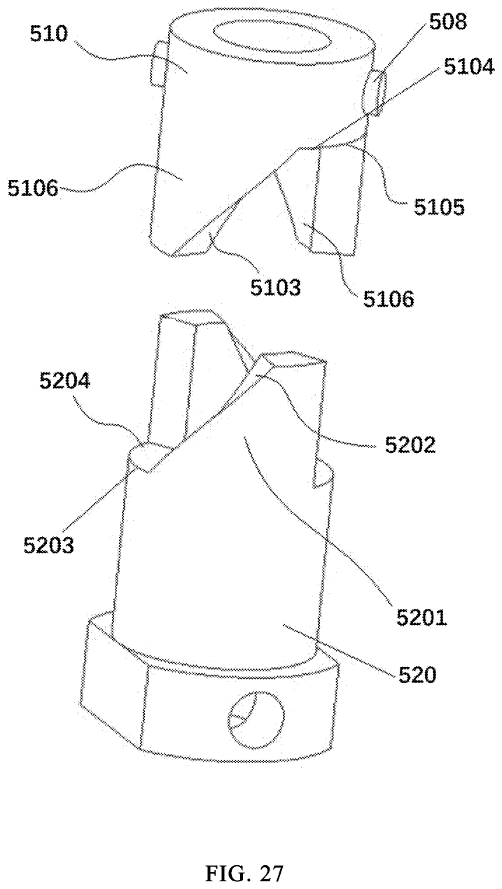

Specifically, the opposing ends of the second driven member 510 and the second driving member 520 are each provided with a force-applying portion formed axially outward, each force-applying portion having a helical surface formed with axial inclination. When the force-applying portion of the second driven member 510 cooperates with the force-applying portion of the second driving member 520, the corresponding helical surfaces are in surface contact to constitute the helical kinematic pair. The axially constraining rotational plane of the second driven member 510 and the second driving member 520 is located outside the bottom of the helical surface of each respective force-applying portion. With reference to FIGS. 26 and 27, the term “outside” here refers, for the second driven member 510, to the right side of its helical surface, and for the second driving member 520, to the left side of its helical surface.

As shown in FIGS. 26 and 27, the second driven member 510 forms a first force-applying portion 5106, and the first force-applying portion 5106 spirals from the upper right toward the lower left to form a first helical surface 5103. A first axial movement-constraining rotation plane 5104 is formed on the upper right side of the first force-applying portion 5106, and the first axial movement-constraining rotation plane 5104 is perpendicular to the axial direction. The lower end surface of the first force-applying portion 5106 is parallel to the first axial movement-constraining rotation plane 5104. Correspondingly, the second driving member 520 forms a second force-applying portion 5201, and the second force-applying portion 5201 spirals from the lower left toward the upper right to form a second helical surface 5202. A second axial movement-constraining rotation plane 5203 is formed on the lower left side of the second force-applying portion 5201, and the second axial movement-constraining rotation plane 5203 is perpendicular to the axial direction. The upper end surface of the second force-applying portion 5201 is a plane and is parallel to the second axial movement-constraining rotation plane 5203. That is, in this embodiment, the second driving member 520 and the second driven member 510 each have two corresponding force-applying portions, and the first force-applying portion 5106, the second force-applying portion 5201, and the corresponding helical surfaces and axial movement-constraining rotation planes form a centrosymmetric structural design. Of course, the present application is not limited thereto; the second driving member 520 and/or the second driven member 510 may each have three or more force-applying portions. Any simple increase or decrease in the number of force-applying portions and corresponding helical surfaces shall fall within the scope of protection of the present application. In addition, in this embodiment, the respective force-applying portions and the respective axial movement-constraining rotation planes of the second driven member 510 and the second driving member 520 are designed to have the same size and shape, which facilitates a closer fit during cooperative operation of the second driven member 510 and the second driving member 520. In other words, the force-applying portions, the helical surfaces, and the axial movement-constraining rotation planes are of the same structural design, only being oppositely oriented during assembly, as shown in FIG. 27.

The first helical surface 5103 is in surface contact with the second helical surface 5202. When the second driven member 510 and the second driving member 520 axially approach each other to the closest position, the second force-applying portion 5201 contacts the first axial movement-constraining rotation plane 5104. At this time, on the right side of the second force-applying portion 5201, that is, in the second direction, a preset space is left between the second driven member 510 and the second driving member 520 to allow the second driving member 520 to further rotate into a first no-load region 5105. That is, in this embodiment, the circumferential dimension of the upper end surface of the second force-applying portion 5201 is smaller than the circumferential dimension of the first axial movement-constraining rotation plane 5104, thereby satisfying the no-load rotation requirement. In other words, when the upper end surface of the second force-applying portion 5201 just comes into contact with the first axial movement-constraining rotation plane 5104, the second driven member 510 has sufficient movement space on the right side (the second direction) of the second force-applying portion 5201. Similarly, in the first direction (the left side shown in FIG. 27), when the lower end surface of the first force-applying portion 5106 contacts the second axial movement-constraining rotation plane 5203, sufficient space is left on the left side (the first direction) of the first force-applying portion 5106 adjacent to the second driving member 520 for further rotation of the second driving member 520 in the second direction, thereby forming a second no-load region 5204.

When the lower end surface of the first force-applying portion 5106 contacts the second axial movement-constraining rotation plane 5203, the upper end surface of the second force-applying portion 5201 also just contacts the first axial movement-constraining rotation plane 5104. In this way, rotation of the second driven member 510 and the second driving member 520 is more stable.

As shown in FIG. 27, the second driven member 510 and the second driving member 520 each have two of the force-applying portions uniformly distributed in the circumferential direction, and the two force-applying portions of the second driven member 510 and the two force-applying portions of the second driving member 520 respectively cooperate to form two pairs of the helical kinematic pairs. That is, the second driven member 510 has two first force-applying portions 5106 in the circumferential direction, and the second driving member 520 has two second force-applying portions 5201 in the circumferential direction. The force-applying portions are uniformly distributed circumferentially and the corresponding helical surfaces are arranged in the same direction. The use of two sets of corresponding force-applying portions to achieve helical transmission fit is more beneficial to the movement stability of the second driven member 510 and the second driving member 520.

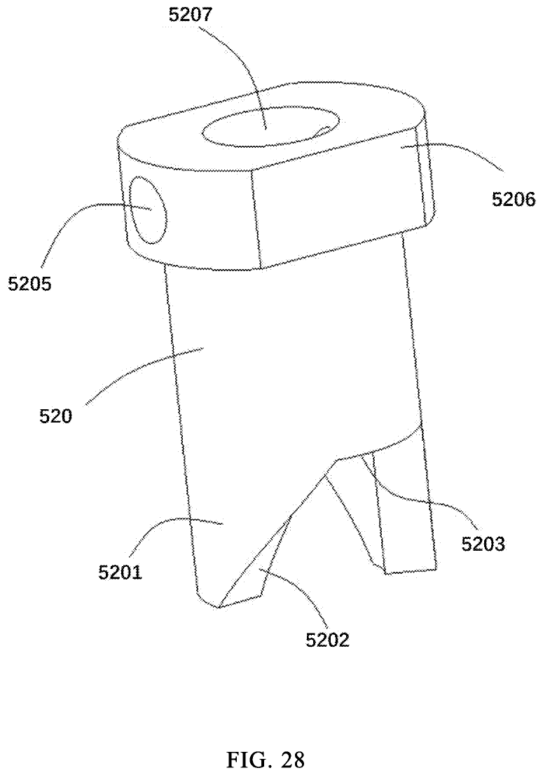

At least a portion of the second driving member 520 is exposed outside the second sleeve 501. Such a solution is configured to facilitate mating the second driving member 520 with an external structure in a particular use environment. Specifically, in one particular embodiment, as shown in FIGS. 22 and 23, the second driving member 520 has a first connecting portion 5206, and the first connecting portion 5206 extends below the second sleeve 501. Since it is exposed during use, assembly is facilitated. Specifically, as shown in FIG. 28, the first connecting portion 5206 is provided with a third assembly hole 5207 extending in the axial direction, and a second assembly hole 5205 extending in the radial direction is provided at the first connecting portion 5206, the second assembly hole 5205 communicating with the third assembly hole 5207. During assembly, an external structure in the particular use environment (for example, a connecting shaft) is inserted into the third assembly hole 5207, and then a screw may pass through the second assembly hole 5205 to lock the connecting shaft.

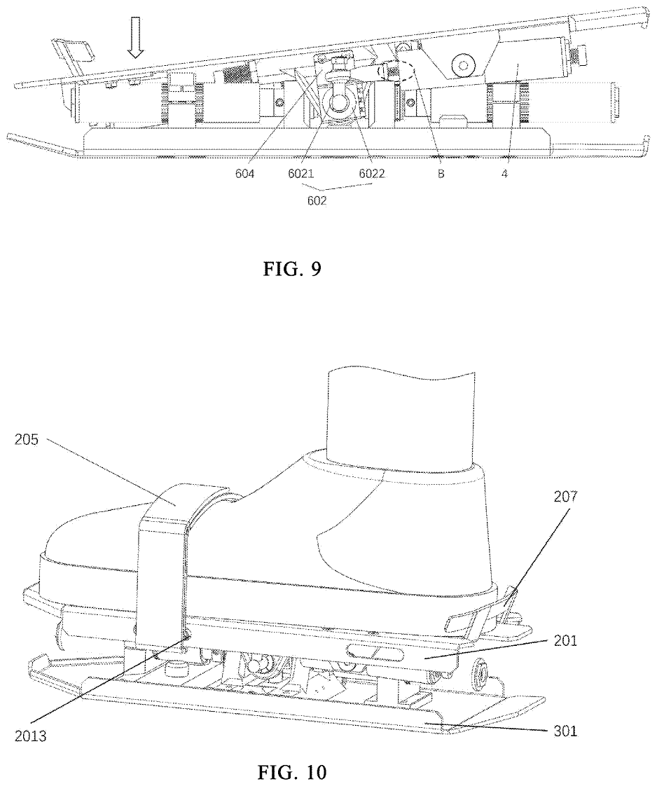

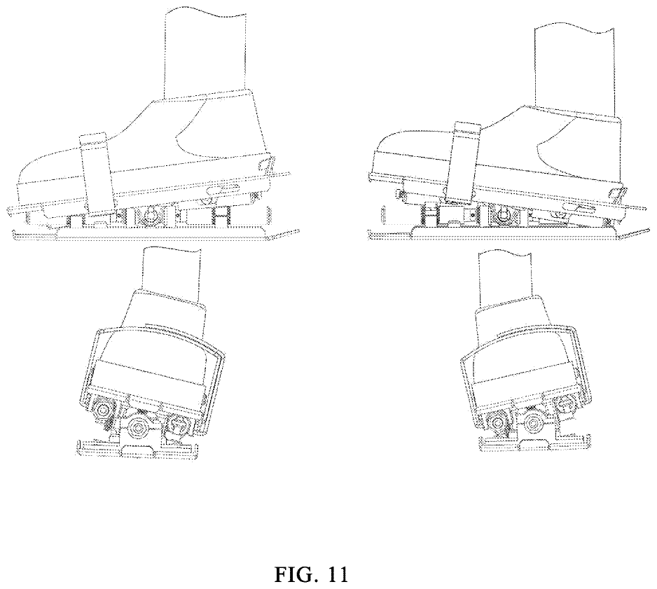

When a force is applied to the rear portion of the pedal 201, as shown in FIG. 8, FIG. 9, and the upper right view of FIG. 11, the pedal 201 drives the upper support frame 202 to rotate about the left-right shaft 102. At this time, of the two compression spring devices 4 at the two ends of the left-right shaft 102, one compression spring device 4 compresses its spring to provide spring force and, as shown by the positions of the two dashed circles A in FIG. 8 and B in FIG. 9, converts the depressing force on the pedal 201 into pressure exerted by the compression spring actuating rod 403 on the compression spring device 4, while the other compression spring device 4, due to the internal limiting thereof, provides neither spring force nor pulling force. The second potentiometer 602 measures a rotational angle of the left-right shaft 102 relative to the upper support frame 202 and outputs a corresponding signal, which is converted into a desired control signal. Similarly, when a force is applied to the front portion of the pedal 201, the opposite occurs, as shown in the upper left view of FIG. 11.

Since the pedal 201 can only rotate forward or backward relative to the six-axis shaft assembly 10 about the left-right shaft 102, when the pedal 201 is depressed leftward, as shown in the lower left view of FIG. 11, the pedal 201 drives the front-rear shaft 101 to rotate together therewith. At this time, of the two torsion spring devices 5 at the two ends of the front-rear shaft 101, one torsion spring device 5 provides torque, while the other torsion spring device 5 does not provide torque. Conversely, when a force is applied to the pedal 201 rightward, the opposite occurs, as shown in the lower right view of FIG. 11. The first potentiometer 601 measures a relative rotational angle between the front-rear shaft 101 and the lower support frame 302 and outputs a corresponding signal, which is converted into a control signal for controlling an in-game object.

In addition to the operation and control in the four directions of front, rear, left, and right shown in FIG. 11, operation and control in other directions may also be performed, for example, toward the front right or in any direction forming any angle with the straight-ahead direction, as shown in FIG. 18. In such a case, the two potentiometers simultaneously measure their respective rotational angles and output corresponding electrical signals, which are processed together and converted into corresponding computer signals to control an in-game object.

Of course, the player may also customize the function of depressing the pedal. For example, applying a forward force to the pedal 201 may realize actions such as running and jumping. In addition, a plurality of toe buttons (not shown) may also be provided on the pedal 201 for implementing functions such as jumping, attacking, and skill release. The buttons are designed as raised circular or elliptical buttons so as to facilitate accurate pressing by the toes. These toe buttons are all electrically connected to the main control board.

The main control board may be connected to a host device or host through a data cable to transmit signals, thereby ensuring a stable, low-latency connection. The main control board may also support Bluetooth 5.0 or a higher version for signal connection with a computer or host, and Bluetooth may be equipped with a 2.4 GHz wireless receiver for connecting devices that do not directly support Bluetooth. Of course, if a Bluetooth wireless mode is used, the foot-operated game controller further includes a rechargeable lithium battery (not shown), and a single charge can satisfy the needs of long gaming sessions. The main control board uses a high-performance, low-power microcontroller, such as an STM32 series microcontroller, to process various sensor data, including but not limited to the data measured by the first potentiometer 601 and the second potentiometer 602, and to communicate with external devices.

In order to meet the gaming needs of different players on different devices, the foot-operated game controller not only supports common PC and console gaming platforms, but can also seamlessly connect with mobile devices such as mobile phones and tablets, allowing players to use foot control for gaming in various scenarios. For example, when away from home, a player may connect the foot-operated controller to a mobile phone via Bluetooth to play mobile games that support foot-control operation, thereby improving the convenience and enjoyment of gameplay.

The pedal 201 may be made of sheet metal to ensure hardness and durability, or may be made of a soft material having a certain supporting force so as to ensure comfort and durability. The second connecting rod 402 may be a spherical rod-end bearing (heim joint).

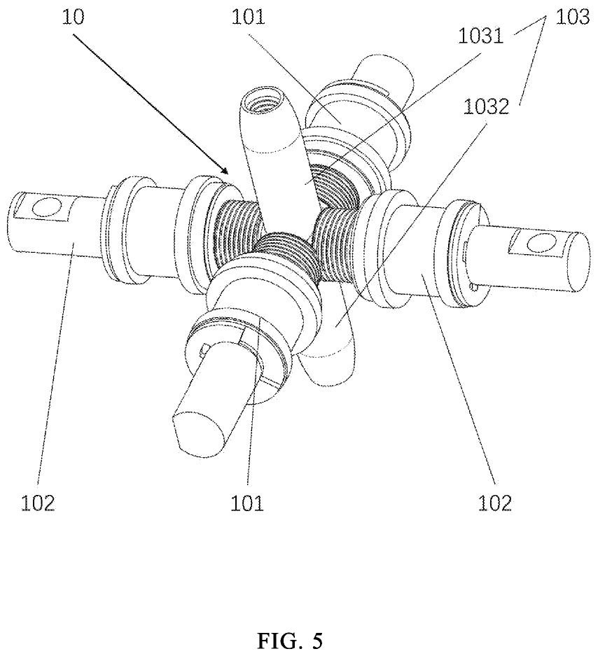

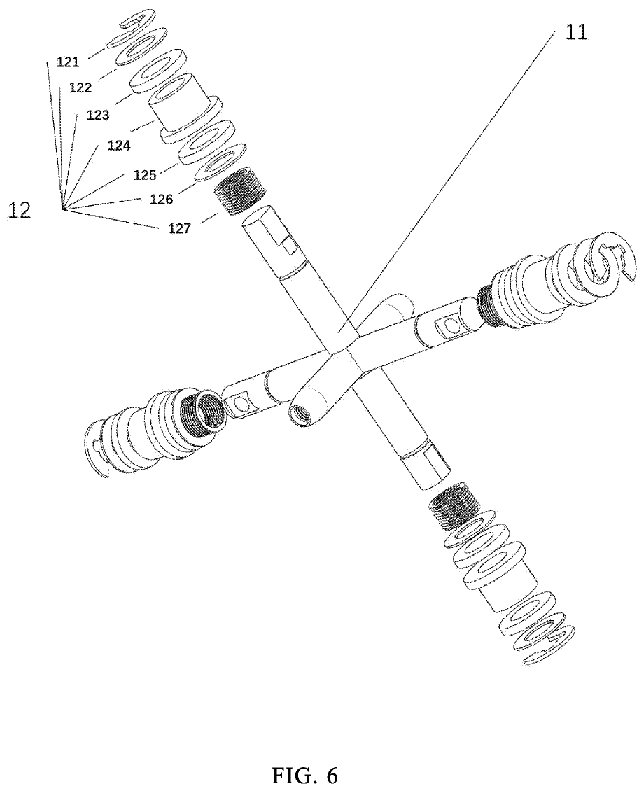

The upper shaft 1031 and the lower shaft 1032 together form the up-down shaft 103, and the front-rear shaft 101, the left-right shaft 102, and the up-down shaft 103 intersect one another perpendicularly to form the six-axis shaft assembly 10, as shown in FIGS. 5 and 6.

The six-axis shaft assembly 10 includes a six-axis shaft body 11 and a six-axis shaft bearing assembly 12 mounted on the six-axis shaft assembly. As shown in FIG. 6, the six-axis shaft bearing assembly 12 includes a first snap ring 121, a first washer 122, a first sealing ring 123, a first sliding bearing sleeve 124, a second sealing ring 125, a second washer 126, and a first spring 127. The above six-axis shaft bearing assembly 12 is mounted on each of the front-rear shaft 101 and the left-right shaft 102.

The upper support frame 202 is vertically arranged on the lower surface of the pedal 201, and the left-right shaft 102 passes through the upper support frame 202.

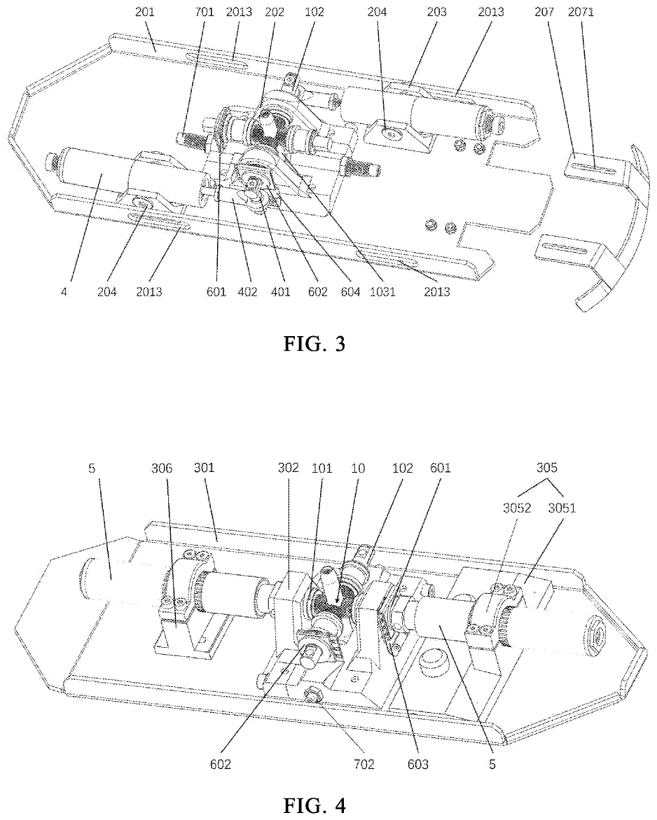

The first potentiometer 601 is mounted by means of the first hanging piece 603, and the second potentiometer 602 is mounted by means of the second hanging piece 604. The first hanging piece 603 is mounted on the lower support frame 302 or the lower plate 301. Specifically, as shown in FIG. 4, the first hanging piece 603 for fixing the first potentiometer 601 is mounted on the lower support frame 302; and as shown in FIG. 3, the second hanging piece 604 for fixing the second potentiometer 602 is mounted on the upper support frame 202. The two hanging pieces are respectively fixedly connected to the lower support frame 302 and the upper support frame 202 by bolts, and the two potentiometers are respectively connected and fixed to the two hanging pieces by snap connection or strong adhesive.

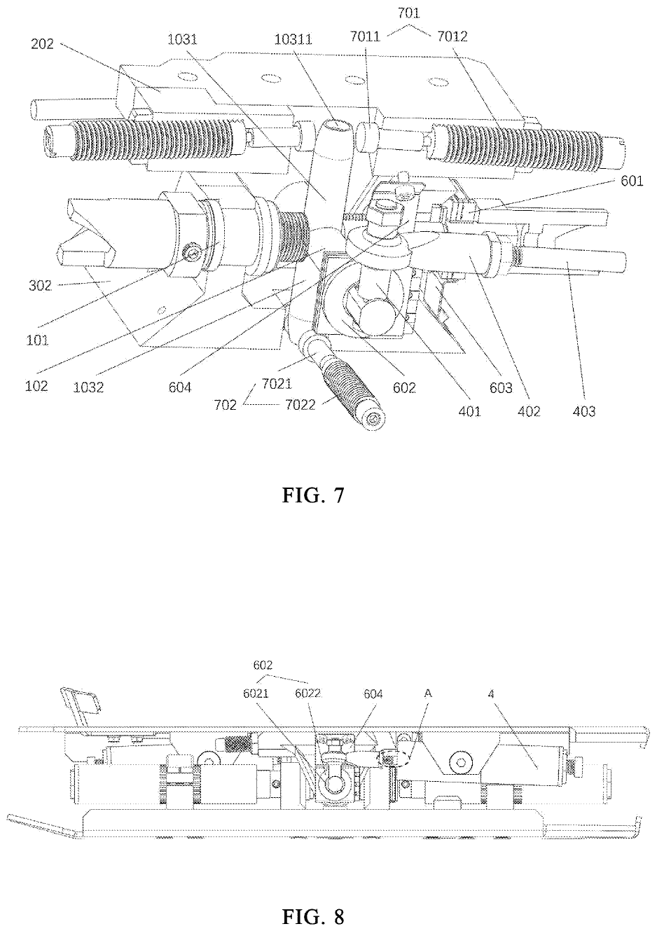

In a specific implementation, as shown in FIG. 7, the upper portion of the six-axis shaft assembly 10 is provided with an upper shaft 1031, and the upper shaft 1031 and the front-rear shaft 101 (or the left-right shaft 102) form a T-shaped shaft. Both the front side and the rear side of the upper shaft 1031 are provided with first damping devices 701. The lower portion of the six-axis shaft assembly 10 is provided with a lower shaft 1032, and the lower shaft 1032 and the front-rear shaft 101 (or the left-right shaft 102) form a T-shaped shaft. Both the left side and the right side of the lower shaft 1032 are provided with second damping devices 702.

Specifically, the first damping device 701 includes a first impact head 7011 and a first damping body 7012 disposed at an end portion of the first impact head 7011. Likewise, the second damping device 702 also includes a second impact head 7021 and a second damping body 7022 disposed at an end portion of the second impact head 7021. Both the first damping body 7012 and the second damping body 7022 are provided with threads, by which they may be threadedly engaged with the upper support frame 202 and the lower support frame 302. The damping body and the impact head are fixedly matched, so that the damping body may be rotationally adjusted to adjust the distance between the impact head of the damping device and the upper shaft 1031 or the lower shaft 1032. For example, when the second potentiometer 602 or the first potentiometer 601 rotates within 3 degrees, the upper shaft 1031 or the lower shaft 1032 does not contact the first damping device 701 or the second damping device 702. At this time, the torque applied to the pedal 201 has a linear relationship with the rotation angle of the potentiometer. When the second potentiometer 602 or the first potentiometer 601 rotates between 3 degrees and 6 degrees, the upper shaft 1031 or the lower shaft 1032 comes into abutting contact with the first damping device 701 or the second damping device 702, that is, the upper shaft 1031 or the lower shaft 1032 contacts the first impact head 7011 or the second impact head 7021. At this time, the torque applied to the pedal 201 is greater, and the relationship between the torque applied to the pedal 201 and the rotation angle of the potentiometer follows another coefficient relationship (because a damper generally contains a spring and damping oil, the damping oil may cause a nonlinear relationship between damping displacement and applied force), and this coefficient is larger than that when no abutting contact with the first damping device 701 or the second damping device 702 occurs. In this way, the user can experience a distinct operational feel when controlling movement of an in-game object; for example, the movement speed of the controlled object in the second case is much faster than that in the first case.

The torque-response coefficient can be changed by means of the two damping devices. For example, when the pedal 201 rotates forward relative to the lower plate 301 by more than 3 degrees, that is, when the rotation angle of the second potentiometer 602 exceeds 3 degrees, the torque-response coefficient experienced by the user changes due to the action of the damping devices. The purpose of doing so is to reflect a difference in movement speed or a difference among control key positions. For example, when the pedal 201 is operated to rotate forward by more than 3 degrees, as shown in the upper left view of FIG. 11, the movement speed of the controlled object is much higher than the speed when the potentiometer rotates within 3 degrees, thereby reflecting fast and slow speeds and enhancing the fun of game operation. The two damping devices may be spring dampers composed of springs and damping elements, the springs providing elastic force and the damping elements providing damping force.

Of course, the first damping device 701 and the second damping device 702 may also be removed, and the torsion spring device 5 and the compression spring device 4 may provide supporting torque for the pedal 201. In this case, the torque applied to the pedal has a certain linear relationship with the rotation angle of the potentiometer, similar to a joystick on a game controller for controlling movement of an in-game object.

If a player is playing a yacht-type game and uses a steering wheel or keyboard to control steering, and only needs to use the feet to control forward throttle and reverse throttle, the present device can be manually configured as a pedal device that can only be tilted forward and backward. In this case, the pedal 201 cannot rotate leftward or rightward relative to the lower plate 301. Similarly, if a player in another game only needs to use the feet to control left and right, the device can also be manually configured as a pedal device that can only be tilted leftward and rightward. That is, by fixing one of the two degrees of freedom (the degree of freedom of rotating about the front-rear shaft 101 and the degree of freedom of rotating about the left-right shaft 102), a device having two degrees of freedom is made to retain only the other degree of freedom.

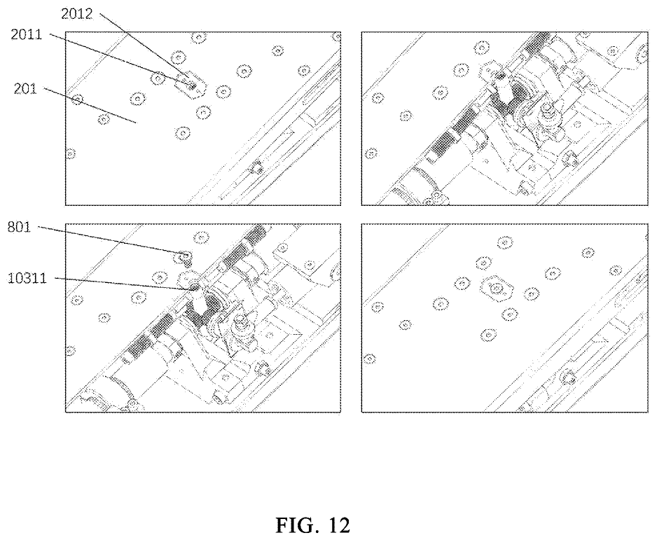

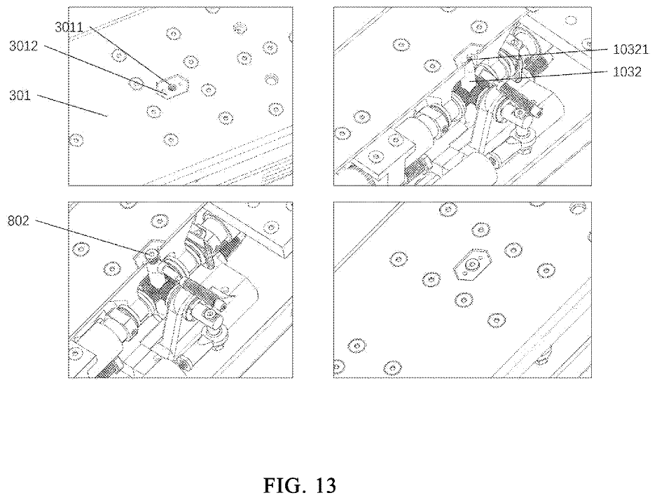

Specifically, the pedal 201 is provided with front-rear limiting holes 2011 for limiting rotation of the pedal 201 relative to the left-right shaft 102, and the upper end portion of the upper shaft 1031 is provided with a first threaded hole 10311 adapted to the front-rear limiting holes 2011, as shown in FIG. 12. The lower plate 301 is provided with left-right limiting holes 3011 for limiting rotation of the lower plate 301 relative to the front-rear shaft 101, as shown in FIG. 13, and the lower end portion of the lower shaft 1032 is provided with a second threaded hole 10321 adapted to the left-right limiting holes 3011. An upper dustproof groove 2012 and a lower dustproof groove 3012 are provided around the front-rear limiting holes 2011 and the left-right limiting holes 3011, respectively. The dustproof grooves may be hexagonal grooves or grooves of other shapes.

If it is not necessary to fix one degree of freedom, the front-rear limiting holes 2011 in the pedal 201 and the left-right limiting holes 3011 in the lower plate 301 can easily allow dust to enter the interior of the device, especially larger dust particles, which may fall into the interior of the device through the front-rear limiting holes 2011 under gravity. Therefore, dustproof covers are required to cover the front-rear limiting holes 2011 and the left-right limiting holes 3011.

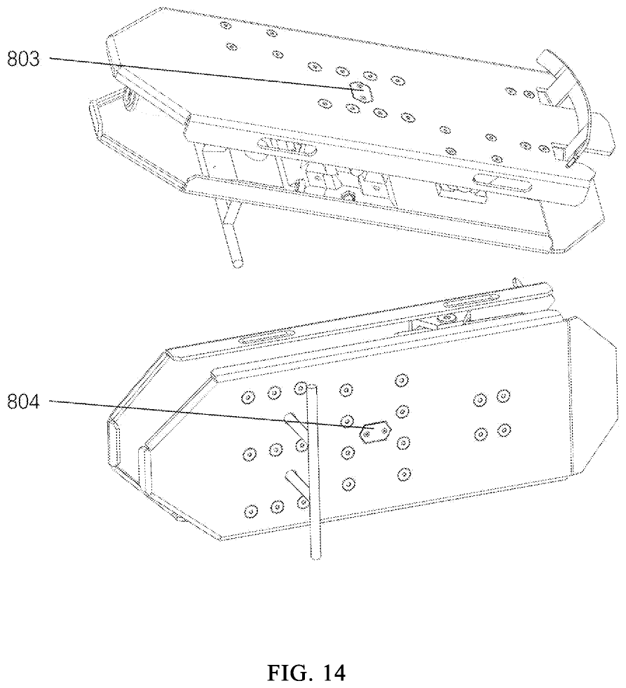

As shown in FIG. 14, the upper dustproof cover 803 and the lower dustproof cover 804 may be made of iron sheets or plastic sheets. Two small bolt holes are provided outside the front-rear limiting holes 2011 and/or the left-right limiting holes 3011, and the two dustproof covers are fixed by screws through the two bolt holes.

### Embodiment 2

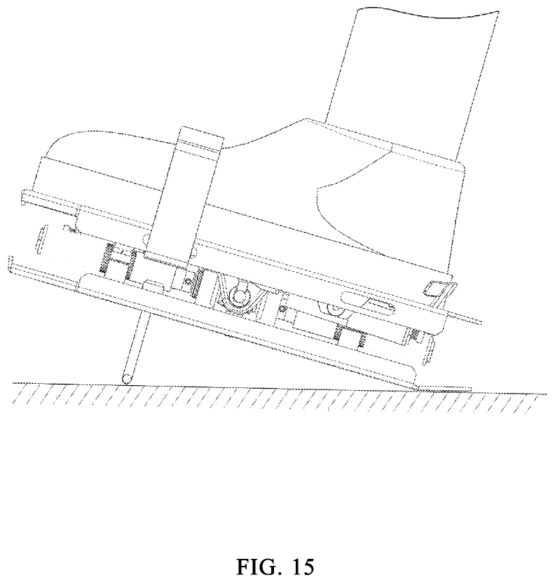

In addition, the device may also provide an inclined placement mode for giving the user a more comfortable posture. As shown in FIG. 15, in a specific implementation, a detachable support frame 31 may be mounted below the front portion of the lower plate 301, and the detachable support frame 31 is used to adjust the overall use angle of the controller. Of course, the support frame may also be omitted and other support mechanisms may be used. Therefore, the support frame needs to be configured in a detachable manner.

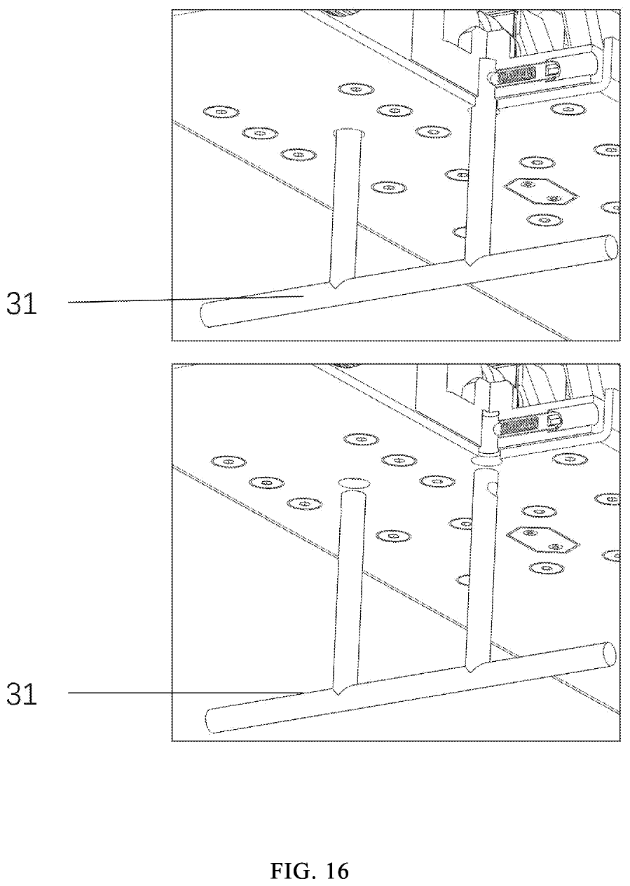

The detachable support frame 31 may be fixed by means of positioning ball plungers (spring balls), as shown in FIG. 16. Specifically, grooves are provided on two support legs of the detachable support frame 31, and the lower plate 301 and the front fixing seat 305 are each provided with two mounting holes adapted to the support legs, while a pair of positioning balls (spring balls) are provided inside the front fixing seat 305. When the support frame is to be used, the two support legs are aligned with and inserted into the mounting holes, and the positioning balls (spring balls) snap into the grooves on the support legs. When the support frame needs to be removed, the detachable support frame 31 only needs to be pulled out with slight force.

A front fixing seat 305 for fixing the torsion spring device 5 is provided on the outer side of the lower support frame 302. The front fixing seat 305 includes a front fixing seat base 3051, the middle portion of which is provided with a semicircular groove. The torsion spring device 5 is mounted in the semicircular groove and then locked and fixed by a semicircular plate 3052.

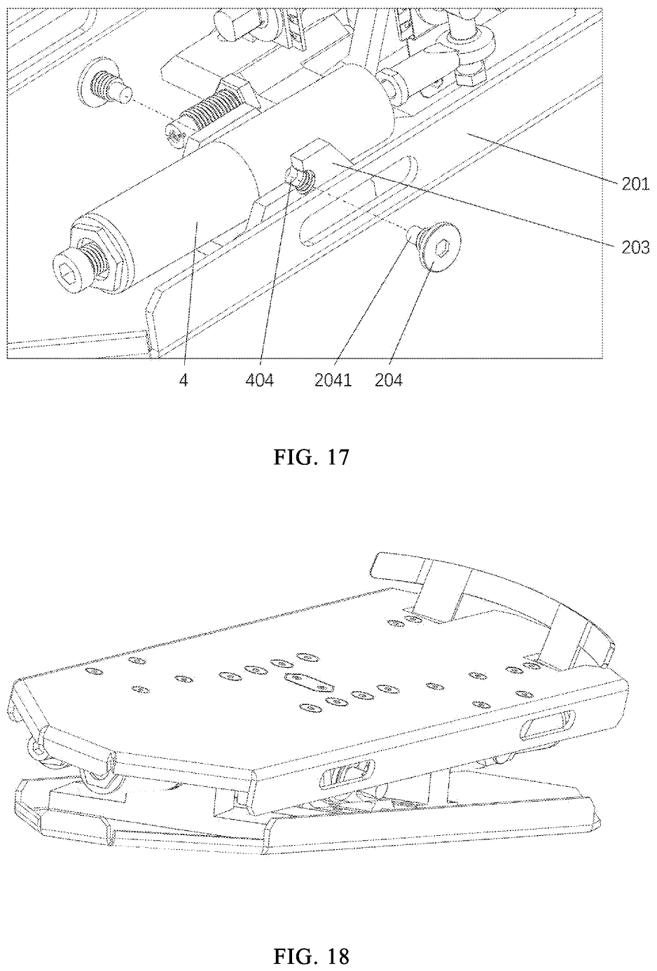

As shown in FIGS. 3 and 17, the lower surface of the pedal 201 is provided with a pair of hanging pieces 203 for fixing the compression spring device 4, and the hanging pieces 203 fix the compression spring device 4 by bolts 204. Specifically, the hanging plate is configured in a U shape, and the compression spring device 4 is clamped in the U-shaped hanging piece 203. The compression spring device 4 is provided with two first assembly holes 404 symmetrically arranged along the central axis, and the two first assembly holes 404 are fixed by two bolts 204. The first assembly holes 404 are smooth inner holes, and the first assembly holes 404 may cooperate with protruding shafts 2041 on the bolts 204 to form rotational-only sliding friction. The bolts 204 are provided with screw portions that may be threadedly engaged with the hanging piece 203. In this manner, the compression spring device 4 may be clamped below the pedal 201, and the compression spring device 4 has only one degree of freedom relative to the pedal 201, namely, the degree of freedom of rotation about the central axis of the protruding shaft 2041.

An arcuate limiting plate 207 is provided at the rear end of the pedal 201. When the controller is placed in an inclined manner, as shown in FIG. 15, that is, when the controller forms a certain angle with the horizontal plane, the arcuate limiting plate 207 helps prevent the foot from slipping off the pedal. Therefore, the arcuate limiting plate 207 is shaped to conform to the heel, that is, in an arcuate shape, so that the foot is more comfortable, especially during prolonged use. A pair of L-shaped connecting plates is provided on the arcuate limiting plate 207, and each L-shaped connecting plate is provided with a waist-shaped hole 2071 for bolt installation, as shown in FIG. 3. The arcuate limiting plate 207 is fixed to the rear end of the pedal 201 by bolts through the waist-shaped holes 2071. By adjusting the assembly position between the waist-shaped holes 2071 and the bolts, the position of the arcuate limiting plate 207 relative to the pedal 201 may be adjusted.

The present application can be used in various games, such as racing games, shooting games, and role-playing games. By using the foot-operated controller to simulate actions such as movement, running, and jumping, the player's gaming experience becomes more immersive, and the controller is particularly suitable for players whose hands are inconvenient to use or who have disabilities affecting both hands.

Compared with a manual game controller, a foot-operated game controller can free the player's hands, enabling the player to focus on other operations. For example, in a strategy game, both hands may be used to operate a mouse for precise clicking and certain complex key operations, while both feet use the foot-operated controller to complete operations such as unit movement and perspective switching, thereby greatly expanding the operation space and improving game operation efficiency. In music rhythm games, both hands may operate instrument performance while both feet control rhythm changes, thereby providing the player with a richer gaming experience.

In addition, prolonged use of a manual game controller easily leads to hand fatigue, whereas a foot-operated game controller can distribute the operational burden to both feet. The muscle groups of both feet are relatively larger and have stronger endurance, making them more suitable for long-term repetitive operation. For example, in a boating game, prolonged use of both hands to control the steering wheel and gear shifting may cause soreness in the hands, whereas using the foot-operated controller to control the throttle and reverse movement can relax the hands, conforms to ergonomic principles, reduces bodily fatigue, and enables the player to engage in the game for a longer period.

For some people whose hands are inconvenient to use or who have disabilities affecting both hands, the present device may also be used for daily office work if needed. The user may customize foot operations to correspond to keyboard keys, thereby solving troubles in daily life and office work caused by hand problems. In addition, when such people play games, they may otherwise be at a disadvantage in intense competitive games because of hand-related issues. Use of the present device can, to a certain extent, compensate for operational problems caused by hand issues, thereby bringing a happier and more pleasant experience to people whose hands are inconvenient to use or who have disabilities affecting both hands.

In the present specification, the pedal 201 and/or the upper support frame 202 cooperates with the six-axis shaft assembly 10 through the left-right shaft 102. Of course, the design may also be such that the pedal 201 and/or the upper support frame 202 cooperates through the front-rear shaft 101, that is, the pedal 201 and/or the upper support frame 202 can only move leftward or rightward relative to the six-axis shaft assembly 10 about the front-rear shaft 101, and the lower plate 301 and/or the lower support frame 302 can only move forward or backward about the left-right shaft 102. In other words, the two structural cooperation relationships between the six-axis shaft assembly 10 and the upper support frame 202 and lower support frame 302 are reversed correspondingly, with the torsion spring device 5 fixed to the pedal 201 and the compression spring device 4 fixed to the lower plate 301. The specific implementation process thereof is based on the same principle as described above. Such a design involving interchange of the cooperation relationships shall fall within the scope of protection of the present application.

In addition, the pedal 201 may be configured for depression by both feet. In this case, the compression spring device 4 may be replaced by the torsion spring device 5.

In summary, the present application discloses a foot-operated game controller, by which an in-game object can be moved by operating the pedal. Meanwhile, the player may also customize the function of depressing the pedal, for example, by applying a forward force to realize actions such as running and jumping. The controller is suitable for players who need to operate a relatively large number of keys and is particularly suitable for players whose hands are inconvenient to use. In addition, the use of damping enables the player to experience a clear speed difference when controlling movement of the in-game object, thereby providing the player with a richer gaming experience.

Obviously, the embodiments described above are merely some embodiments of the present application, rather than all embodiments. The accompanying drawings illustrate preferred embodiments of the present application, but do not limit the patent scope of the present application. The present application may be implemented in many different forms; on the contrary, these embodiments are provided so that the disclosure of the present application will be more thorough and complete. Any equivalent structures made by using the contents of the specification and drawings of the present application, and directly or indirectly applied in other related technical fields, shall likewise fall within the patent protection scope of the present application.

What is claimed is:

1. A foot-operated game controller, comprising:
a six-axis shaft assembly comprising a front-rear shaft and a left-right shaft;
a pedal positioned above the six-axis shaft assembly, a pair of upper support frames being provided on a lower surface of the pedal, the pedal being fixedly connected to the upper support frames, the pair of upper support frames being symmetrically arranged at opposite ends of the left-right shaft, both ends of the left-right shaft being provided with first connecting rods, each first connecting rod being hingedly connected at one end to a second connecting rod, the second connecting rod being connected to a compression spring actuating rod, the compression spring actuating rod terminating in a compression spring device, one side of each upper support frame being provided with a second potentiometer configured to measure a rotational angle of the left-right shaft relative to the upper support frame, a hollow shaft portion of the second potentiometer being fixedly provided on the left-right shaft, and a resistive element of the second potentiometer being fixedly provided on the upper support frame;
a lower plate positioned below the six-axis shaft assembly, an upper surface of the lower plate being provided with a pair of lower support frames for supporting a shaft portion of the front-rear shaft, the lower plate being fixedly connected to the lower support frames, opposite ends of the front-rear shaft being connected to torsion spring devices, the lower support frames being provided with a first potentiometer configured to measure a rotational angle of the front-rear shaft relative to the lower support frames, a hollow shaft portion of the first potentiometer being fixedly provided on the front-rear shaft, and a resistive element of the first potentiometer being fixedly provided on the lower support frames;
wherein both potentiometers are electrically connected to a main control board;
wherein, when a force is applied to a front portion or a rear portion of the pedal, the pedal drives the upper support frames to rotate forward or backward about the left-right shaft, the second potentiometer measures a change in the rotational angle of the upper support frames relative to the left-right shaft, and the main control board receives the measured angle data, converts the angle data into a digital signal, and transmits the digital signal to a host device, thereby controlling an in-game object to move forward or backward; and
wherein, because the pedal is only capable of tilting forward and backward about the left-right shaft relative to the six-axis shaft assembly, when a force is applied to a left portion or a right portion of the pedal, the pedal remains stationary relative to the six-axis shaft assembly, and the six-axis shaft assembly follows the pedal so as to rotate leftward or rightward about the front-rear shaft relative to the lower support frames, the first potentiometer measures a rotational angle of the front-rear shaft relative to the lower support frames, and the main control board receives the measured angle data, converts the angle data into a digital signal, and transmits the digital signal to the host device, thereby controlling the in-game object to move leftward or rightward.

2. The foot-operated game controller according to claim 1, wherein an outer side of the lower support frames is provided with a front fixing seat and a rear fixing seat for fixing the torsion spring devices.

3. The foot-operated game controller according to claim 1, wherein the lower surface of the pedal is provided with a pair of hanging pieces for fixing the compression spring devices, and the hanging pieces clamp the compression spring devices by bolts.

4. The foot-operated game controller according to claim 1, wherein the pedal is rotatable relative to the lower plate about the front-rear shaft and the left-right shaft; when the lower plate contacts the ground and the torsion spring devices and the compression spring devices are not subjected to external force, the pedal is in a balanced state; and when the pedal is subjected to external force, the pedal is deflectable in a direction corresponding to the applied force, and, when the external force is removed, the pedal returns to the balanced state under the action of the torsion spring devices and the compression spring devices.

5. The foot-operated game controller according to claim 1, wherein an upper portion of the six-axis shaft assembly is provided with an upper shaft, the upper shaft and one of the front-rear shaft and the left-right shaft forming a T-shaped shaft, and front and rear sides of the upper shaft are each provided with a first damping device;
a lower portion of the six-axis shaft assembly is provided with a lower shaft, the lower shaft and one of the front-rear shaft and the left-right shaft forming a T-shaped shaft, and left and right sides of the lower shaft are each provided with a second damping device.

6. The foot-operated game controller according to claim 5, wherein the pedal is provided with front-rear limiting holes for mounting first limiting bolts capable of limiting rotation of the upper support frames relative to the six-axis shaft assembly about the left-right shaft, and an upper end portion of the upper shaft is provided with a first threaded hole adapted to the first limiting bolts;
and the lower plate is provided with left-right limiting holes for mounting second limiting bolts capable of limiting rotation of the lower support frames relative to the six-axis shaft assembly about the front-rear shaft, and a lower end portion of the lower shaft is provided with a second threaded hole adapted to the second limiting bolts.

7. The foot-operated game controller according to claim 6, wherein outward-facing surfaces of the front-rear limiting holes and the left-right limiting holes are respectively provided with a polygonal upper dustproof groove and a lower dustproof groove.

8. The foot-operated game controller according to claim 7, wherein the upper dustproof groove and the lower dustproof groove are respectively provided with an upper dustproof cover and a lower dustproof cover.

9. The foot-operated game controller according to claim 1, wherein a detachable support frame is arranged below a front portion of the lower plate.

10. The foot-operated game controller according to claim 1, wherein a rear end of the pedal is provided with an arcuate limiting plate.

11. The foot-operated game controller according to claim 1, wherein the compression spring device comprises:
a first sleeve, an elastic-force pre-adjustment assembly, a third spring, and a first driven member, the first sleeve having a first hollow portion; the elastic-force pre-adjustment assembly, the third spring, and the first driven member being arranged from top to bottom in the first hollow portion of the first sleeve;
wherein two ends of the third spring respectively abut against the elastic-force pre-adjustment assembly and the first driven member, and, under a no-external-force condition, the third spring causes the first driven member to be located at a third position within the first sleeve, the elastic-force pre-adjustment assembly being controllable to compress or release the third spring so as to change a magnitude of elastic force exerted by the third spring on the first driven member;
wherein the compression spring actuating rod is partially sleeved within the first sleeve, one end of the compression spring actuating rod extending outside the first sleeve and another end thereof abutting against the first driven member so as to transmit force along an axial direction of the first sleeve, and, when an axial external force applied to the compression spring actuating rod toward the third spring is greater than the elastic force exerted by the third spring on the first driven member, the compression spring actuating rod drives the first driven member to slide along the axial direction of the first sleeve to a fourth position so as to compress the third spring;
further comprising a first sub-sleeve, wherein a slideway is axially provided in the first sub-sleeve for axial reciprocating movement of the compression spring actuating rod;
wherein, when the compression spring actuating rod is subjected to force, the compression spring actuating rod reciprocates axially in the slideway and, upon entering the slideway inside the first sub-sleeve, is configured to abut against the first driven member so as to transmit force.

12. The foot-operated game controller according to claim 11, wherein an upper snap-fit assembly and a lower snap-fit assembly are arranged on an inner side of a bottom portion of the first sleeve;
the upper snap-fit assembly and the lower snap-fit assembly each comprise a second snap ring and a third washer;
the upper snap-fit assembly is arranged above the first sub-sleeve, and the lower snap-fit assembly is arranged below the first sub-sleeve;
and the upper snap-fit assembly and the lower snap-fit assembly cooperate so as to constrain the first sub-sleeve on the inner side of the bottom portion of the first sleeve.

13. The foot-operated game controller according to claim 12, wherein a third sealing ring is provided in the first sleeve, an upper surface of the third sealing ring abutting against a lower surface of the first sub-sleeve, and a lower surface of the third sealing ring abutting against an upper surface of the lower snap-fit assembly;
wherein the elastic-force pre-adjustment assembly comprises a first moving member and a first main shaft, the first moving member being sleeved on an outer periphery of the first main shaft and being screw-connected to the first main shaft, and a lower side of the first moving member abutting against a top of the third spring;
wherein, when the first main shaft is rotated by an external force, the first moving member moves axially downward or upward relative to the first main shaft so as to change an extension/compression state of the third spring;
and an outer end portion of the first main shaft is provided with a first adjustment portion.

14. The foot-operated game controller according to claim 13, wherein the elastic-force pre-adjustment assembly further comprises a first steel ball, and the first main shaft is provided with a first positioning groove adapted to the first steel ball;
and the first steel ball falls into the first positioning groove so as to limit rotation of the first main shaft.

15. The foot-operated game controller according to claim 13, wherein the compression spring device further comprises:
a first end cap;
wherein the first end cap has a first assembly region, a bottom of the first assembly region having a first passage, a bottom portion of the first main shaft extending from the first passage into the first hollow portion of the first sleeve, and the first adjustment portion being exposed outside the first end cap;
wherein a first thrust bearing is provided in the first assembly region, an upper surface of the first thrust bearing abutting against a lower end of a fourth spring, and a lower surface of the first thrust bearing abutting against a bottom of an inner surface of the first assembly region.

16. The foot-operated game controller according to claim 1, wherein the torsion spring device comprises:
a second sleeve having a second hollow portion; a second main shaft arranged axially in the second hollow portion; and a second moving member, a seventh spring, a fifth spring, a second driven member, and a second driving member arranged from top to bottom in the second hollow portion of the second sleeve, the second moving member, the seventh spring, the fifth spring, the second driven member, and the second driving member being sleeved from top to bottom around an outer periphery of the second main shaft;
wherein two ends of the fifth spring respectively abut against the second moving member and the second driven member so as to apply elastic force to the second moving member and the second driven member; and the second moving member is threadedly connected to the second main shaft and constrainedly fitted with the second sleeve, so as to realize position adjustment of axial reciprocating movement of the second moving member when the second main shaft rotates;
wherein the second driven member is constrainedly fitted with the second sleeve so as to reciprocate axially when driven; and the second driving member and the second driven member are in driving cooperation through a helical kinematic pair, so that when the second driving member rotates under external force in a first direction, the second driving member drives the second driven member to move upward so as to compress the fifth spring, and after the external force is removed, the second driving member returns under the action of the fifth spring in a second direction opposite to the first direction; and
wherein an upper end of the second main shaft has a second adjustment portion, the second adjustment portion being exposed through an upper opening of the second hollow portion of the second sleeve so as to cooperate with an external device to realize rotational adjustment of the second main shaft.

17. The foot-operated game controller according to claim 16, wherein the second driven member and the second driving member have, at a bottom end of the helical kinematic pair, an axial movement-constraining rotation plane perpendicular to an axial direction, the axial movement-constraining rotation plane being configured to constrain axial movement of the second driven member and the second driving member and to provide space for lateral non-driving rotational movement after the helical kinematic pair between the second driven member and the second driving member is disengaged.

18. The foot-operated game controller according to claim 16, wherein opposing ends of the second driven member and the second driving member each have a force-applying portion formed to project outward along the axial direction, each force-applying portion having a helical surface formed obliquely along the axial direction, and when a first force-applying portion of the second driven member cooperates with a second force-applying portion of the second driving member, corresponding helical surfaces are in surface contact to constitute the helical kinematic pair, and the axial movement-constraining rotation planes of the second driven member and the second driving member are located outside bottoms of the helical surfaces of the respective force-applying portions.

19. The foot-operated game controller according to claim 18, wherein the second driven member and the second driving member each have two of the force-applying portions uniformly distributed along a circumferential direction, and the two force-applying portions of the second driven member and the two force-applying portions of the second driving member respectively cooperate to form two pairs of the helical kinematic pairs.

20. The foot-operated game controller according to claim 16, wherein the second main shaft is assembled and connected with a first limiting assembly at an upper end of the sleeve so as to constrain downward displacement of the second main shaft;
and a lower end of the second main shaft is detachably connected with a second limiting assembly, the second limiting assembly being located below the second driving member such that the second driving member is at least partially located within the sleeve.
